(19) United States
(12) Patent Application Publication
(10) Pub. No.: US 2025/0203605 A1
(43) Pub. Date: Jun. 19, 2025

(54) DATA TRANSMISSION METHOD AND COMMUNICATION APPARATUS

(71) Applicant: HUAWEI TECHNOLOGIES CO., LTD., Shenzhen (CN)

(72) Inventors: Ting Wang, Shanghai (CN); Jianglei Ma, Ottawa (CA); Dongdong Wei, Shenzhen (CN); Xiaoyan Bi, Shanghai (CN); Hao Tang, Shanghai (CN); Na Gao, Shanghai (CN)

(73) Assignee: HUAWEI TECHNOLOGIES CO., LTD., Shenzhen (CN)

(21) Appl. No.: 19/069,152

(22) Filed: Mar. 3, 2025

Related U.S. Application Data
(63) Continuation of application No. PCT/CN2022/118645, filed on Sep. 14, 2022.

(51) Int. Cl. H04W 72/1263; H04W 72/543

(52) U.S. Cl. CPC H04W 72/1263; H04W 72/543

(57) ABSTRACT

This application provides a data transmission method and a communication apparatus. The method includes: A first communication apparatus receives first information, where the first information is used to schedule transmission of first data and transmission of second data, the first data corresponds to a first reliability level, the second data corresponds to a second reliability level, and the first reliability level is different from the second reliability level; the first communication apparatus determines second information, where a first correspondence exists between the second information and both the first reliability level and the second reliability level; and the first communication apparatus transmits the first data and the second data based on the second information.

### CROSS-REFERENCE TO RELATED APPLICATIONS

This application is a continuation of International Application No. PCT/CN2022/118645, filed on Sep. 14, 2022, which is entitled “DATA TRANSMISSION METHOD AND COMMUNICATION APPARATUS”, which is incorporated herein by reference in its entirety.

### TECHNICAL FIELD

This application relates to the field of communication technologies, and more specifically, to a data transmission method and a communication apparatus.

### BACKGROUND

With development of communication technologies, a plurality of new service types emerge currently, for example, an ultra-reliable low-latency communication (URLLC) service type, an enhanced mobile broadband (eMBB) service type, a massive machine-type communication (mMTC) service type, a sensing (sensing) service type, and an artificial intelligence (AI) service type.

A current scheduling and transmission mechanism is for transmission of data of a single service type of a terminal device. However, the terminal device may have a requirement of simultaneously transmitting data of a plurality of different service types. If data is still scheduled and transmitted in the foregoing manner, an overall data transmission latency is long. Therefore, the current scheduling and transmission mechanism cannot meet the requirement of transmitting the data of the plurality of service types of the terminal device.

### SUMMARY

This application provides a data transmission method and a communication apparatus, to simultaneously transmit data of a plurality of different service types, thereby reducing an overall data transmission latency.

According to a first aspect, a data transmission method is provided, including: A first communication apparatus receives first information, where the first information is used to schedule transmission of first data and transmission of second data, the first data corresponds to a first reliability level, the second data corresponds to a second reliability level, and the first reliability level is different from the second reliability level; the first communication apparatus determines second information, where a first correspondence exists between the second information and both the first reliability level and the second reliability level; and the first communication apparatus transmits the first data and the second data based on the second information.

When transmission is sending, the first communication apparatus may send the first data and the second data to a second communication apparatus based on the second information. When transmission is receiving, the first communication apparatus may receive, based on the second information, the first data and the second data that are sent by a second communication apparatus.

According to the foregoing technical solution, in this application, data of a plurality of reliability levels can be simultaneously transmitted, and different service types may correspond to different reliability levels. In this way, an overall data transmission latency can be reduced. In addition. This application can further improve overall data transmission efficiency.

Specifically, in this application, the matched second information can be determined based on the reliability level of the data. In this way, the data of the plurality of reliability levels can be simultaneously transmitted, and the data transmission latency can be reduced.

In an optional implementation, the method further includes: The first communication apparatus receives third information, where the third information indicates the first communication apparatus to perform measurement feedback on a first channel and measurement feedback on a second channel, the first channel corresponds to a third reliability level, and the second channel corresponds to a fourth reliability level; the first communication apparatus determines fourth information, where a second correspondence exists between the fourth information and both the third reliability level and the fourth reliability level; and the first communication apparatus sends measurement feedback information of the first channel and measurement feedback information of the second channel based on the fourth information.

According to the foregoing technical solution, in this application, matched layer numbers of transport blocks and matched channel quality indicator (CQI) tables can be configured for channel measurement feedback for a plurality of reliability levels, to support simultaneous transmission of a plurality of pieces of data. In this way, the overall data transmission latency can be reduced, and data transmission efficiency can be improved.

Specifically, a plurality of pieces of data of different reliability levels are transmitted in one time of data scheduling, which can meet CQI feedback under different reliability level requirements, and can improve communication performance.

According to a second aspect, a data transmission method is provided, including: A second communication apparatus sends first information, where the first information is used to schedule transmission of first data and transmission of second data, the first data corresponds to a first reliability level, the second data corresponds to a second reliability level, and the first reliability level is different from the second reliability level; the second communication apparatus determines second information, where a first correspondence exists between the second information and both the first reliability level and the second reliability level; and the second communication apparatus transmits the first data and the second data based on the second information.

When transmission is sending, the second communication apparatus may send the first data and the second data to a first communication apparatus based on the second information. When transmission is receiving, the second communication apparatus may receive, based on the second information, the first data and the second data that are sent by a first communication apparatus.

According to the foregoing technical solution, in this application, data of a plurality of different service types (or reliability levels) can be simultaneously transmitted. In this way, an overall data transmission latency can be reduced. In addition. This application can further improve overall data transmission efficiency.

Specifically, in this application, the matched second information can be determined based on the reliability level of the data. In this way, the data of the plurality of reliability levels can be simultaneously transmitted, and the data transmission latency can be reduced.

In an optional implementation, the method further includes: The second communication apparatus sends third information, where the third information indicates the first communication apparatus to perform measurement feedback on a first channel and measurement feedback on a second channel, the first channel corresponds to a third reliability level, and the second channel corresponds to a fourth reliability level; the second communication apparatus determines fourth information, where a second correspondence exists between the fourth information and both the third reliability level and the fourth reliability level; and the second communication apparatus receives measurement feedback information of the first channel and measurement feedback information of the second channel based on the fourth information.

With reference to the technical solutions of the first aspect and the second aspect, there is any one of the following optional implementations:

In an optional implementation, the second information includes at least one of the following: a layer number of a transport block, a time domain resource, a frequency domain resource, a logical channel, a code block unit, a modulation and coding scheme MCS table, or an MCS index.

For example, spatial multiplexing of data transmission can be implemented by determining the layer number of the transport block corresponding to the reliability level of the data; time division multiplexing or frequency division multiplexing of data transmission can be implemented by determining the time domain resource or the frequency domain resource corresponding to the reliability level of the data; and code division multiplexing of data transmission can be implemented by determining the code block unit corresponding to the reliability level of the data.

In an optional implementation, the layer number of the transport block includes a layer number of a first transport block and a layer number of a second transport block, the layer number of the first transport block corresponds to the first reliability level, and the layer number of the second transport block corresponds to the second reliability level; or the time domain resource includes a first time domain resource and a second time domain resource, the first time domain resource corresponds to the first reliability level, and the second time domain resource corresponds to the second reliability level; or the frequency domain resource includes a first frequency domain resource and a second frequency domain resource, the first frequency domain resource corresponds to the first reliability level, and the second frequency domain resource corresponds to the second reliability level; or the logical channel includes a first logical channel and a second logical channel, the first logical channel corresponds to the first reliability level, and the second logical channel corresponds to the second reliability level; or the code block unit includes a first code block unit and a second code block unit, the first code block unit corresponds to the first reliability level, and the second code block unit corresponds to the second reliability level; or the MCS table includes a first MCS table and a second MCS table, the first MCS table corresponds to the first reliability level, and the second MCS table corresponds to the second reliability level; or the MCS index includes a first MCS index and a second MCS index, the first MCS index corresponds to the first reliability level, the second MCS index corresponds to the second reliability level, the first MCS index corresponds to the first MCS table, and the second MCS index corresponds to the second MCS table.

In an optional implementation, the first logical channel corresponds to the first code block unit, and the second logical channel corresponds to the second code block unit.

According to the foregoing technical solution, logical channels can be properly allocated for transmission, to meet transmission requirements of different logical channels. Different logical channels correspond to different code block units, and independent code block unit processing may be performed, to meet requirements of different services as required, and improve communication performance.

In an optional implementation, the first code block unit is configured to transmit the first data, the second code block unit is configured to transmit the second data, and the first code block unit and the second code block unit belong to a third transport block; and the first code block unit and the second code block unit meet any one of the following: the first code block unit includes a first transport block cyclic redundancy check, and the second code block unit does not include the first transport block cyclic redundancy check; or the first code block unit does not include a first transport block cyclic redundancy check, and the second code block unit includes the first transport block cyclic redundancy check; or the first code block unit includes a first transport block cyclic redundancy check, and the second code block unit includes a second transport block cyclic redundancy check; or the first code block unit includes a first code block cyclic redundancy check, and the second code block unit does not include the first code block cyclic redundancy check; or the first code block unit includes a first code block cyclic redundancy check, and the second code block unit includes a second code block cyclic redundancy check.

According to the foregoing several composition forms of the code block unit, in this application, the first data and the second data can be quickly decoded.

In an optional implementation, the second information further includes: an index, where the index is used to determine at least one of the MCS table and the MCS index.

According to the foregoing technical solution, the communication apparatus may implement joint indication of the MCS table and the MCS index via the second information, and determine a plurality of MCS tables, to meet transmission requirements of different services, reduce signaling overheads, and improve communication performance.

Specifically, the MCS index is used to determine one or more corresponding rows of parameters in the MCS table.

In an optional implementation, the index includes at least one of: a first index, indicating the first MCS table and the first MCS index; a second index, indicating the second MCS table and the second MCS index; a third index, indicating the first MCS index and the second MCS index; a fourth index, indicating the first MCS table and the second MCS table; a fifth index, indicating the first MCS table; a sixth index, indicating the first MCS index; a seventh index, indicating the second MCS table; an eighth index, indicating the second MCS index; or a ninth index, indicating the first MCS table, the first MCS index, the second MCS table, and the second MCS index.

In an optional implementation, a difference between the first MCS index and the second MCS index is a first value; and the second MCS index is determined by the first communication apparatus based on the first MCS index and the first value; or the first MCS index is determined by the first communication apparatus based on the second MCS index and the first value.

In this way, signaling overheads can be reduced.

In an optional implementation, a difference between an index of the first MCS table and an index of the second MCS table is a second value; and the index of the second MCS table is determined by the first communication apparatus based on the index of the first MCS table and the second value; or the index of the first MCS table is determined by the first communication apparatus based on the index of the second MCS table and the second value.

In this way, signaling overheads can be reduced.

In an optional implementation, the first information further indicates the first reliability level and the second reliability level.

In an optional implementation, the fourth information includes at least one of the following: a layer number of a transport block, a CQI table, or a signal-to-noise ratio threshold.

According to the foregoing technical solution, the communication apparatus may determine the fourth information based on the reliability levels, to determine layer numbers, CQI tables, and/or signal-to-noise ratio thresholds at different reliability levels, meet service transmission with different reliability requirements, implement channel measurement feedback with different requirements, and improve communication performance.

In an optional implementation, the layer number of the transport block includes a layer number of a fourth transport block and a layer number of a fifth transport block, the layer number of the fourth transport block corresponds to the third reliability level, and the layer number of the fifth transport block corresponds to the fourth reliability level; or the CQI table includes a first CQI table and a second CQI table, the first CQI table corresponds to the third reliability level, and the second CQI table corresponds to the fourth reliability level.

In an optional implementation, the signal-to-noise ratio threshold is used to determine the layer number of the fourth transport block and the layer number of the fifth transport block; and a signal-to-noise ratio of each of layers of the fourth transport block is greater than or equal to the signal-to-noise ratio threshold, and a signal-to-noise ratio of each of the layers of the fifth transport block is less than the signal-to-noise ratio threshold; or a signal-to-noise ratio of each of layers of the fourth transport block is less than the signal-to-noise ratio threshold, and a signal-to-noise ratio of each of the layers of the fifth transport block is greater than or equal to the signal-to-noise ratio threshold.

According to the foregoing technical solution, the communication apparatus may determine, based on the signal-to-noise ratio threshold, layer numbers at different reliability levels, to meet service transmission with different reliability requirements, implement channel measurement feedback with different requirements, properly and efficiently use signal-to-noise ratio information, and improve communication performance.

In an optional implementation, the first correspondence is predefined in a protocol, or the first correspondence is indicated by the second communication apparatus to the first communication apparatus.

In an optional implementation, the first value is predefined in a protocol, or the first value is indicated by the second communication apparatus to the first communication apparatus.

In an optional implementation, the second value is predefined in a protocol, or the second value is indicated by the second communication apparatus to the first communication apparatus.

In an optional implementation, the signal-to-noise ratio threshold is predefined in a protocol, or the signal-to-noise ratio threshold is indicated by the second communication apparatus to the first communication apparatus.

According to a third aspect, a data transmission method is provided, including: A first communication apparatus receives third information, where the third information indicates the first communication apparatus to perform measurement feedback on a first channel and measurement feedback on a second channel, the first channel corresponds to a third reliability level, and the second channel corresponds to a fourth reliability level; the first communication apparatus determines fourth information, where a second correspondence exists between the fourth information and both the third reliability level and the fourth reliability level; and the first communication apparatus sends measurement feedback information of the first channel and measurement feedback information of the second channel based on the fourth information.

According to a fourth aspect, a data transmission method is provided, including: A second communication apparatus sends third information, where the third information indicates a first communication apparatus to perform measurement feedback on a first channel and measurement feedback on a second channel, the first channel corresponds to a third reliability level, and the second channel corresponds to a fourth reliability level; the second communication apparatus determines fourth information, where a second correspondence exists between the fourth information and both the third reliability level and the fourth reliability level; and the second communication apparatus receives measurement feedback information of the first channel and measurement feedback information of the second channel based on the fourth information.

According to the technical solutions in the third aspect and/or the fourth aspect, in this application, matched layer numbers of transport blocks and matched CQI tables can be configured for channel measurement feedback for a plurality of reliability levels, to support simultaneous transmission of a plurality of pieces of data. In this way, an overall data transmission latency can be reduced, and data transmission efficiency can be improved.

Specifically, a plurality of pieces of data of different reliability are transmitted in one time of data scheduling, which can meet CQI feedback under different reliability level requirements, and can improve communication performance.

With reference to the third aspect and/or the fourth aspect, there is any one of the following optional implementations:

In an optional implementation, the fourth information includes at least one of the following: a layer number of a transport block, a channel quality indicator CQI table, or a signal-to-noise ratio threshold.

In an optional implementation, the layer number of the transport block includes a layer number of a fourth transport block and a layer number of a fifth transport block, the layer number of the fourth transport block corresponds to the third reliability level, and the layer number of the fifth transport block corresponds to the fourth reliability level; or the CQI table includes a first CQI table and a second CQI table, the first CQI table corresponds to the third reliability level, and the second CQI table corresponds to the fourth reliability level.

In an optional implementation, the signal-to-noise ratio threshold is used to determine the layer number of the fourth transport block and the layer number of the fifth transport block; and a signal-to-noise ratio of each of layers of the fourth transport block is greater than or equal to the signal-to-noise ratio threshold, and a signal-to-noise ratio of each of the layers of the fifth transport block is less than the signal-to-noise ratio threshold; or a signal-to-noise ratio of each of layers of the fourth transport block is less than the signal-to-noise ratio threshold, and a signal-to-noise ratio of each of the layers of the fifth transport block is greater than or equal to the signal-to-noise ratio threshold.

In an optional implementation, the signal-to-noise ratio threshold is predefined in a protocol, or the signal-to-noise ratio threshold is indicated by the second communication apparatus to the first communication apparatus.

According to a fifth aspect, a communication apparatus is provided. The communication apparatus may be used in the first communication apparatus according to the first aspect. The communication apparatus may be a terminal device, or may be an apparatus in a terminal device (for example, a chip, a chip system, or a circuit), or an apparatus that can be used in cooperation with a terminal device.

In an optional implementation, the communication apparatus may include modules or units that one-to-one correspond to the methods/operations/steps/actions described in the first aspect. The module or unit may be a hardware circuit, or may be software, or may be implemented by a hardware circuit in combination with software.

In an optional implementation, the communication apparatus includes: a transceiver unit, configured to receive first information, where the first information is used to schedule transmission of first data and transmission of second data, the first data corresponds to a first reliability level, the second data corresponds to a second reliability level, and the first reliability level is different from the second reliability level; and a processing unit, configured to determine second information, where a first correspondence exists between the second information and both the first reliability level and the second reliability level, where the transceiver unit is further configured to transmit the first data and the second data based on the second information.

In an optional implementation, the transceiver unit is further configured to receive third information, where the third information indicates the communication apparatus to perform measurement feedback on a first channel and measurement feedback on a second channel, the first channel corresponds to a third reliability level, and the second channel corresponds to a fourth reliability level. The processing unit is further configured to determine fourth information, where a second correspondence exists between the fourth information and both the third reliability level and the fourth reliability level. The transceiver unit is further configured to send measurement feedback information of the first channel and measurement feedback information of the second channel based on the fourth information.

According to a sixth aspect, a communication apparatus is provided. The communication apparatus may be used in the second communication apparatus according to the second aspect. The communication apparatus may be a network device, or may be an apparatus in a network device (for example, a chip, a chip system, or a circuit), or an apparatus that can be used in cooperation with a network device.

In an optional implementation, the communication apparatus may include modules or units that one-to-one correspond to the method/operations/steps/actions described in the second aspect. The module or unit may be a hardware circuit, or may be software, or may be implemented by a hardware circuit in combination with software.

In an optional implementation, the communication apparatus includes: a transceiver unit, configured to send first information, where the first information is used to schedule transmission of first data and transmission of second data, the first data corresponds to a first reliability level, the second data corresponds to a second reliability level, and the first reliability level is different from the second reliability level; and a processing unit, configured to determine second information, where a first correspondence exists between the second information and both the first reliability level and the second reliability level, where the transceiver unit is further configured to transmit the first data and the second data based on the second information.

In an optional implementation, the transceiver unit is further configured to send third information, where the third information indicates a first communication apparatus to perform measurement feedback on a first channel and measurement feedback on a second channel, the first channel corresponds to a third reliability level, and the second channel corresponds to a fourth reliability level. The processing unit is further configured to determine fourth information, where a second correspondence exists between the fourth information and both the third reliability level and the fourth reliability level. The transceiver unit is further configured to receive measurement feedback information of the first channel and measurement feedback information of the second channel based on the fourth information.

With reference to the technical solutions of the fifth aspect and the sixth aspect, there is any one of the following optional implementations:

In an optional implementation, the second information includes at least one of the following: a layer number of a transport block, a time domain resource, a frequency domain resource, a logical channel, a code block unit, a modulation and coding scheme MCS table, or an MCS index.

In an optional implementation, the layer number of the transport block includes a layer number of a first transport block and a layer number of a second transport block, the layer number of the first transport block corresponds to the first reliability level, and the layer number of the second transport block corresponds to the second reliability level; or the time domain resource includes a first time domain resource and a second time domain resource, the first time domain resource corresponds to the first reliability level, and the second time domain resource corresponds to the second reliability level; or the frequency domain resource includes a first frequency domain resource and a second frequency domain resource, the first frequency domain resource corresponds to the first reliability level, and the second frequency domain resource corresponds to the second reliability level; or the logical channel includes a first logical channel and a second logical channel, the first logical channel corresponds to the first reliability level, and the second logical channel corresponds to the second reliability level; or the code block unit includes a first code block unit and a second code block unit, the first code block unit corresponds to the first reliability level, and the second code block unit corresponds to the second reliability level; or the MCS table includes a first MCS table and a second MCS table, the first MCS table corresponds to the first reliability level, and the second MCS table corresponds to the second reliability level; or the MCS index includes a first MCS index and a second MCS index, the first MCS index corresponds to the first reliability level, the second MCS index corresponds to the second reliability level, the first MCS index corresponds to the first MCS table, and the second MCS index corresponds to the second MCS table.

In an optional implementation, the first logical channel corresponds to the first code block unit, and the second logical channel corresponds to the second code block unit.

In an optional implementation, the first code block unit is configured to transmit the first data, the second code block unit is configured to transmit the second data, and the first code block unit and the second code block unit belong to a third transport block; and the first code block unit and the second code block unit meet any one of the following: the first code block unit includes a first transport block cyclic redundancy check, and the second code block unit does not include the first transport block cyclic redundancy check; or the first code block unit does not include a first transport block cyclic redundancy check, and the second code block unit includes the first transport block cyclic redundancy check; or the first code block unit includes a first transport block cyclic redundancy check, and the second code block unit includes a second transport block cyclic redundancy check; or the first code block unit includes a first code block cyclic redundancy check, and the second code block unit does not include the first code block cyclic redundancy check; or the first code block unit includes a first code block cyclic redundancy check, and the second code block unit includes a second code block cyclic redundancy check.

In an optional implementation, the second information further includes: an index, where the index is used to determine at least one of the MCS table and the MCS index.

In an optional implementation, the index includes at least one of: a first index, indicating the first MCS table and the first MCS index; a second index, indicating the second MCS table and the second MCS index; a third index, indicating the first MCS index and the second MCS index; a fourth index, indicating the first MCS table and the second MCS table; a fifth index, indicating the first MCS table; a sixth index, indicating the first MCS index; a seventh index, indicating the second MCS table; an eighth index, indicating the second MCS index; or a ninth index, indicating the first MCS table, the first MCS index, the second MCS table, and the second MCS index.

In an optional implementation, a difference between the first MCS index and the second MCS index is a first value; and the second MCS index is determined by the communication apparatus based on the first MCS index and the first value; or the first MCS index is determined by the communication apparatus based on the second MCS index and the first value.

In an optional implementation, a difference between an index of the first MCS table and an index of the second MCS table is a second value; and the index of the second MCS table is determined by the communication apparatus based on the index of the first MCS table and the second value; or the index of the first MCS table is determined by the communication apparatus based on the index of the second MCS table and the second value.

In an optional implementation, the fourth information includes at least one of the following: a layer number of a transport block, a channel quality indicator CQI table, or a signal-to-noise ratio threshold.

In an optional implementation, the layer number of the transport block includes a layer number of a fourth transport block and a layer number of a fifth transport block, the layer number of the fourth transport block corresponds to the third reliability level, and the layer number of the fifth transport block corresponds to the fourth reliability level; or the CQI table includes a first CQI table and a second CQI table, the first CQI table corresponds to the third reliability level, and the second CQI table corresponds to the fourth reliability level.

In an optional implementation, the signal-to-noise ratio threshold is used to determine the layer number of the fourth transport block and the layer number of the fifth transport block; and a signal-to-noise ratio of each of layers of the fourth transport block is greater than or equal to the signal-to-noise ratio threshold, and a signal-to-noise ratio of each of the layers of the fifth transport block is less than the signal-to-noise ratio threshold; or a signal-to-noise ratio of each of layers of the fourth transport block is less than the signal-to-noise ratio threshold, and a signal-to-noise ratio of each of the layers of the fifth transport block is greater than or equal to the signal-to-noise ratio threshold.

In an optional implementation, the first information further indicates the first reliability level and the second reliability level.

In an optional implementation, the first correspondence is predefined in a protocol, or the first correspondence is indicated by the second communication apparatus to the first communication apparatus.

In an optional implementation, the first value is predefined in a protocol, or the first value is indicated by the second communication apparatus to the first communication apparatus.

In an optional implementation, the second value is predefined in a protocol, or the second value is indicated by the second communication apparatus to the first communication apparatus.

In an optional implementation, the signal-to-noise ratio threshold is predefined in a protocol, or the signal-to-noise ratio threshold is indicated by the second communication apparatus to the first communication apparatus.

According to a seventh aspect, a communication apparatus is provided. The communication apparatus may be used in the first communication apparatus according to the third aspect. The communication apparatus may be a terminal device, or may be an apparatus in a terminal device (for example, a chip, a chip system, or a circuit), or an apparatus that can be used in cooperation with a terminal device.

In an optional implementation, the communication apparatus may include modules or units that one-to-one correspond to the methods/operations/steps/actions described in the third aspect. The module or unit may be a hardware circuit, or may be software, or may be implemented by a hardware circuit in combination with software.

In an optional implementation, the communication apparatus includes: a transceiver unit, configured to receive third information, where the third information indicates the communication apparatus to perform measurement feedback on a first channel and measurement feedback on a second channel, the first channel corresponds to a third reliability level, and the second channel corresponds to a fourth reliability level; and a processing unit, configured to determine fourth information, where a second correspondence exists between the fourth information and both the third reliability level and the fourth reliability level, where the transceiver unit is further configured to send measurement feedback information of the first channel and measurement feedback information of the second channel based on the fourth information.

In an optional implementation, the fourth information includes at least one of the following: a layer number of a transport block, a channel quality indicator CQI table, or a signal-to-noise ratio threshold.

In an optional implementation, the layer number of the transport block includes a layer number of a fourth transport block and a layer number of a fifth transport block, the layer number of the fourth transport block corresponds to the third reliability level, and the layer number of the fifth transport block corresponds to the fourth reliability level; or the CQI table includes a first CQI table and a second CQI table, the first CQI table corresponds to the third reliability level, and the second CQI table corresponds to the fourth reliability level.

In an optional implementation, the signal-to-noise ratio threshold is used to determine the layer number of the fourth transport block and the layer number of the fifth transport block; and a signal-to-noise ratio of each of layers of the fourth transport block is greater than or equal to the signal-to-noise ratio threshold, and a signal-to-noise ratio of each of the layers of the fifth transport block is less than the signal-to-noise ratio threshold; or a signal-to-noise ratio of each of layers of the fourth transport block is less than the signal-to-noise ratio threshold, and a signal-to-noise ratio of each of the layers of the fifth transport block is greater than or equal to the signal-to-noise ratio threshold.

According to an eighth aspect, a communication apparatus is provided. The communication apparatus may be used in the second communication apparatus according to the fourth aspect. The communication apparatus may be a network device, or may be an apparatus in a network device (for example, a chip, a chip system, or a circuit), or an apparatus that can be used in cooperation with a network device.

In an optional implementation, the communication apparatus may include modules or units that one-to-one correspond to the methods/operations/steps/actions described in the fourth aspect. The module or unit may be a hardware circuit, or may be software, or may be implemented by a hardware circuit in combination with software.

In an optional implementation, the communication apparatus includes: a transceiver unit, configured to send third information, where the third information indicates a first communication apparatus to perform measurement feedback on a first channel and measurement feedback on a second channel, the first channel corresponds to a third reliability level, and the second channel corresponds to a fourth reliability level; and a processing unit, configured to determine fourth information, where a second correspondence exists between the fourth information and both the third reliability level and the fourth reliability level, where the transceiver unit is further configured to receive measurement feedback information of the first channel and measurement feedback information of the second channel based on the fourth information.

In an optional implementation, the fourth information includes at least one of the following: a layer number of a transport block, a channel quality indicator CQI table, or a signal-to-noise ratio threshold.

In an optional implementation, the layer number of the transport block includes a layer number of a fourth transport block and a layer number of a fifth transport block, the layer number of the fourth transport block corresponds to the third reliability level, and the layer number of the fifth transport block corresponds to the fourth reliability level; or the CQI table includes a first CQI table and a second CQI table, the first CQI table corresponds to the third reliability level, and the second CQI table corresponds to the fourth reliability level.

In an optional implementation, the signal-to-noise ratio threshold is used to determine the layer number of the fourth transport block and the layer number of the fifth transport block; and a signal-to-noise ratio of each of layers of the fourth transport block is greater than or equal to the signal-to-noise ratio threshold, and a signal-to-noise ratio of each of the layers of the fifth transport block is less than the signal-to-noise ratio threshold; or a signal-to-noise ratio of each of layers of the fourth transport block is less than the signal-to-noise ratio threshold, and a signal-to-noise ratio of each of the layers of the fifth transport block is greater than or equal to the signal-to-noise ratio threshold.

According to a ninth aspect, a communication apparatus is provided, including a processor. The processor is configured to enable, by executing a computer program or instructions or through a logical circuit, the communication apparatus to perform the method according to any one of the first aspect and the optional implementations of the first aspect, or the communication apparatus to perform the method according to any one of the second aspect and the optional implementations of the second aspect, or the communication apparatus to perform the method according to any one of the third aspect and the optional implementations of the third aspect, or the communication apparatus to perform the method according to any one of the fourth aspect and the optional implementations of the fourth aspect.

In an optional implementation, the apparatus further includes a memory, and the memory is configured to store the computer program or the instructions.

Optionally, the processor and the memory are integrated together, or the processor and the memory are disposed separately.

In another optional implementation, the memory is located outside the communication apparatus.

In an optional implementation, the communication apparatus further includes a communication interface, and the communication interface is configured to input a signal and/or output a signal.

For example, the communication interface may be a transceiver, a circuit, a bus, a module, or another type of communication interface.

According to a tenth aspect, a communication apparatus is provided, including a logic circuit and an input/output interface. The input/output interface is configured to output a signal and/or input a signal. The logic circuit is configured to perform the method according to any one of the first aspect and the optional implementations of the first aspect, or perform the method according to any one of the second aspect and the optional implementations of the second aspect, or perform the method according to any one of the third aspect and the optional implementations of the third aspect, or perform the method according to any one of the fourth aspect and the optional implementations of the fourth aspect.

In an optional implementation, the input/output interface is configured to input first information, where the first information is used to schedule transmission of first data and transmission of second data, the first data corresponds to a first reliability level, the second data corresponds to a second reliability level, and the first reliability level is different from the second reliability level. The logic circuit is configured to determine second information, where a first correspondence exists between the second information and both the first reliability level and the second reliability level. The input/output interface is further configured to transmit the first data and the second data based on the second information.

In an optional implementation, the input/output interface is configured to input third information, where the third information indicates the first communication apparatus to perform measurement feedback on a first channel and measurement feedback on a second channel, the first channel corresponds to a third reliability level, and the second channel corresponds to a fourth reliability level. The logic circuit is configured to determine fourth information, where a second correspondence exists between the fourth information and both the third reliability level and the fourth reliability level. The input/output interface is further configured to output measurement feedback information of the first channel and measurement feedback information of the second channel based on the fourth information.

In an optional implementation, the input/output interface is configured to output first information, where the first information is used to schedule transmission of first data and transmission of second data, the first data corresponds to a first reliability level, the second data corresponds to a second reliability level, and the first reliability level is different from the second reliability level. The logic circuit is configured to determine second information, where a first correspondence exists between the second information and both the first reliability level and the second reliability level. The input/output interface is further configured to transmit the first data and the second data based on the second information.

In an optional implementation, the input/output interface is configured to output third information, where the third information indicates a first communication apparatus to perform measurement feedback on a first channel and measurement feedback on a second channel, the first channel corresponds to a third reliability level, and the second channel corresponds to a fourth reliability level. The logic circuit is configured to determine fourth information, where a second correspondence exists between the fourth information and both the third reliability level and the fourth reliability level. The input/output interface is further configured to input measurement feedback information of the first channel and measurement feedback information of the second channel based on the fourth information.

According to an eleventh aspect, a computer-readable storage medium is provided, including a computer program or instructions. When the computer program or the instructions are run on a computer, the computer is enabled to perform the method according to any one of the first aspect and the optional le implementations of the first aspect, or the computer is enabled to perform the method according to any one of the second aspect and the optional implementations of the second aspect, or the computer is enabled to perform the method according to any one of the third aspect and the optional implementations of the third aspect, or the computer is enabled to perform the method according to any one of the fourth aspect and the optional implementations of the fourth aspect.

According to a twelfth aspect, a computer program product is provided, including instructions. When the instructions are run on a computer, the computer is enabled to perform the method according to any one of the first aspect and the optional le implementations of the first aspect, or the computer is enabled to perform the method according to any one of the second aspect and the optional implementations of the second aspect, or the computer is enabled to perform the method according to any one of the third aspect and the optional implementations of the third aspect, or the computer is enabled to perform the method according to any one of the fourth aspect and the optional implementations of the fourth aspect.

According to a thirteenth aspect, an embodiment of this application further provides a first communication apparatus, configured to perform the method according to the first aspect and the optional implementations of the first aspect, or configured to perform the method according to the second aspect and the optional implementations of the second aspect.

According to a fourteenth aspect, an embodiment of this application further provides a second communication apparatus, configured to perform the method according to the third aspect and the optional implementations of the third aspect, or configured to perform the method according to the fourth aspect and the optional implementations of the fourth aspect.

According to a fifteenth aspect, an embodiment of this application further provides a communication system, including the first communication apparatus provided in the fifth aspect, the sixth aspect, and the optional implementations of the foregoing aspects, and the second communication apparatus provided in the seventh aspect, the eighth aspect, and the optional implementations of the foregoing aspects.

### BRIEF DESCRIPTION OF DRAWINGS

FIG. 1 is a diagram of a communication system 100 to which an embodiment of this application is applicable;

FIG. 2 is a schematic interaction flowchart of a data transmission method 200 according to an embodiment of this application;

FIG. 3 is a schematic interaction flowchart of a data transmission method 300 according to an embodiment of this application;

FIG. 4 is a schematic interaction flowchart of a data transmission method 400 according to an embodiment of this application;

FIG. 5 is a schematic interaction flowchart of a data transmission method 500 according to an embodiment of this application;

FIG. 6 is a diagram of a correspondence between a code block unit, a logical channel, and a reliability level;

FIG. 7 is a diagram of a correspondence between a code block unit and a cyclic redundancy check;

FIG. 8 is a schematic interaction flowchart of a data transmission method 800 according to an embodiment of this application;

FIG. 9 is a schematic interaction flowchart of a data transmission method 900 according to an embodiment of this application;

FIG. 10(a) to FIG. 10(f) are a schematic interaction flowchart of a data transmission method 1000 according to an embodiment of this application;

FIG. 11 is a schematic interaction flowchart of a data transmission method 1100 according to an embodiment of this application;

FIG. 12 is a diagram of a correspondence between a logical channel and a reliability level;

FIG. 13 is a block diagram of a structure of a communication apparatus 1300 according to an embodiment of this application;

FIG. 14 is a block diagram of a structure of a communication apparatus 1400 according to an embodiment of this application;

FIG. 15 is a block diagram of a structure of a communication apparatus 1500 according to an embodiment of this application;

FIG. 16 is a block diagram of a structure of a communication apparatus 1600 according to an embodiment of this application; and

FIG. 17 is a block diagram of a structure of a communication apparatus 1700 according to an embodiment of this application.

### DESCRIPTION OF EMBODIMENTS

The following describes technical solutions of this application with reference to accompanying drawings.

The technical solutions in embodiments of this application may be applied to various communication systems, for example, a long term evolution (LTE) system, an LTE frequency division duplex (FDD) system, an LTE time division duplex (TDD) system, a universal mobile telecommunications system (UMTS), a 5th generation (5G) system or a new radio (NR) system, an evolved system after 5G like a 6th generation (6G) system, or non-terrestrial network (NTN) systems such as an inter-satellite communication system and a satellite communication system. The satellite communication system includes a satellite base station and a terminal device. The satellite base station provides a communication service for the terminal device. The satellite base station may also communicate with a terrestrial base station. A satellite may be used as a base station, or may be used as a terminal device. The satellite may be a non-terrestrial base station, a non-terrestrial device, or the like, for example, an unmanned aerial vehicle, a hot air balloon, a low earth orbit satellite, a medium earth orbit satellite, or a high earth orbit satellite.

The technical solutions in embodiments of this application are applicable to both a homogeneous network scenario and a heterogeneous network scenario. In addition, a transmission point is not limited. Coordinated multipoint transmission may be performed between macro base stations, between micro base stations, and between a macro base station and a micro base station. The technical solutions in embodiments of this application are applicable to the FDD/TDD system. The technical solutions in embodiments of this application are applicable to not only a low-frequency scenario (sub 6G), but also a high-frequency scenario (above 6 GHZ), terahertz, optical communication, and the like. The technical solutions in embodiments of this application are applicable to not only communication between a network device and a terminal, but also communication between network devices, communication between terminals, communication in the internet of vehicles, communication in the internet of things, communication in the industrial internet, and the like.

The technical solutions in embodiments of this application may also be applied to a scenario in which a terminal is connected to a single base station. The base station connected to the terminal and a core network (CN) connected to the base station are of a same standard. For example, if the CN is a 5G core, the base station is correspondingly a 5G base station, and the 5G base station is directly connected to the 5G core. Alternatively, if the CN is a 6G core, the base station is a 6G base station, and the 6G base station is directly connected to the 6G core. The technical solutions in embodiments of this application are also applicable to a dual connectivity (DC) scenario in which a terminal is connected to at least two base stations.

The technical solutions in embodiments of this application are also applicable to a macro-micro scenario including different forms of base stations in a communication network. For example, the base station may be a satellite, an air balloon station, or an unmanned aerial vehicle station. The technical solutions in embodiments of this application are also applicable to a scenario in which both a wide-coverage base station and a small-coverage base station exist.

It may be further understood that the technical solutions in embodiments of this application may be further applied to 5.5 G, 6 G, and later wireless communication systems. Application scenarios include but are not limited to scenarios such as ground cellular communication, NTN, satellite communication, high altitude platform station (HAPS) communication, vehicle-to-everything (V2X), integrated access and backhaul (IAB), and reconfigurable intelligent surface (RIS) communication.

The terminal in embodiments of this application may be a device having a wireless transceiver function, and may be specifically user equipment (UE), an access terminal, a subscriber unit (subscriber unit), a subscriber station, a mobile station (mobile station), a remote station, a remote terminal, a mobile device, a user terminal, a wireless communication device, a user agent, or a user apparatus. The terminal device may alternatively be a satellite phone, a cellular phone, a smartphone, a wireless data card, a wireless modem, or a machine-type communication device, or may be a cordless phone, a session initiation protocol (SIP) phone, a wireless local loop (WLL) station, a personal digital assistant (PDA), customer-premises equipment (CPE), a smart point of sale (POS) machine, a handheld device having a wireless communication function, a computing device or another processing device connected to a wireless modem, a vehicle-mounted device, a communication device carried on a high-altitude aircraft, a wearable device, an unmanned aerial vehicle, a robot, a terminal in device-to-device (D2D) communication, a terminal in V2X, a virtual reality (VR) terminal device, an augmented reality (AR) terminal device, a wireless terminal in industrial control (industrial control), a wireless terminal in self-driving (self-driving), a wireless terminal in remote medical (remote medical), a wireless terminal in a smart grid (smart grid), a wireless terminal in transportation safety (transportation safety), a wireless terminal in a smart city (smart city), a wireless terminal in a smart home (smart home), a terminal device in an evolved communication network after 5G, or the like. This is not limited in embodiments of this application.

In embodiments of this application, an apparatus configured to implement a function of the terminal device may be the terminal device, or may be an apparatus that can support the terminal device in implementing the function, for example, a chip system. The apparatus may be installed in the terminal device, or may be used in cooperation with the terminal device. In embodiments of this application, the chip system may include a chip, or may include a chip and another discrete component.

The network device in embodiments of this application is a device having a wireless transceiver function, and is configured to communicate with a terminal device. An access network device may be a node in a radio access network (RAN), and may be referred to as a base station, or may be referred to as a RAN node. The access network device may be an evolved NodeB (eNB or eNodeB) in LTE, a base station in a 5G network like a gNodeB (gNB), a base station in an evolved public land mobile network (PLMN) after 5G, a broadband network gateway (BNG), an aggregation switch, a 3rd generation partner project (3GPP) access device, or the like.

The network device in embodiments of this application may further include various forms of base stations, for example, a macro base station, a micro base station (also referred to as a small cell), a relay station, a transmission reception point (TRP), a transmission point (TP), a mobile switching center, and devices that undertake base station functions in device-to-device (D2D), vehicle-to-everything (V2X), and machine-to-machine (M2M) communication. The network device may further include a central unit (CU) and a distributed unit (DU) in a cloud access network (C-RAN) system, or a network device in an NTN communication system. This is not specifically limited in embodiments of this application.

In embodiments of this application, an apparatus configured to implement a function of the network device may be the network device, or may be an apparatus that can support the network device in implementing the function, for example, a chip system. The apparatus may be installed in the network device or used in cooperation with the network device. In embodiments of this application, the chip system may include a chip, or may include a chip and another discrete component.

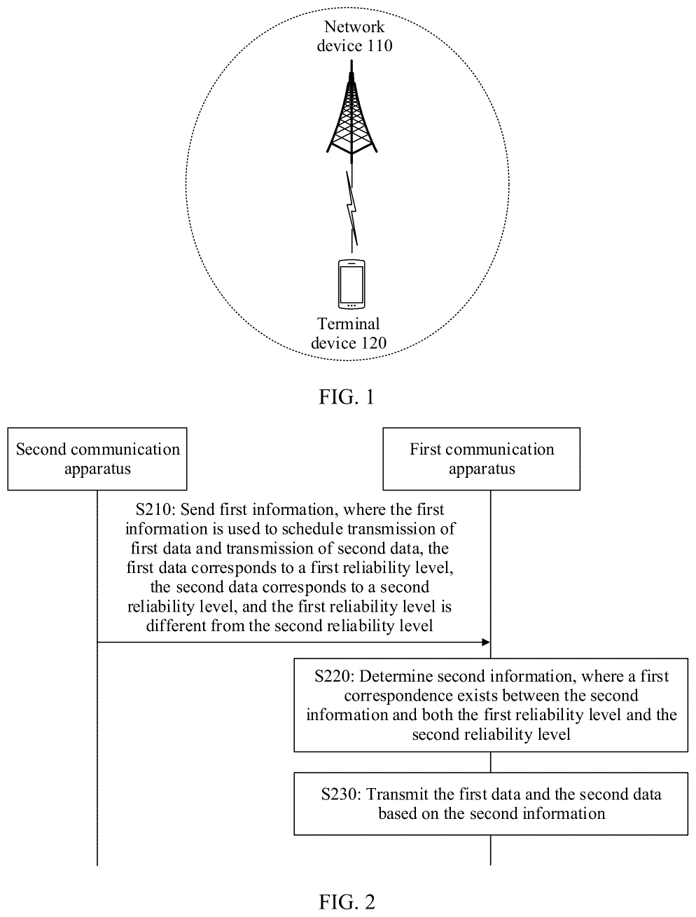

FIG. 1 is a diagram of a communication system 100 to which an embodiment of this application is applicable. As shown in FIG. 1, the communication system 100 includes a network device 110 and a terminal device 120. A quantity of terminal devices 120 and a quantity of network devices 110 included in the communication system 100 are not limited in embodiments of this application. In addition, FIG. 1 is merely an example for understanding, and cannot limit the protection scope claimed in this application. The terminal device 120 may be any terminal device listed above, and the network device 110 may also be any network device listed above.

In the communication system 100, the network device 110 may schedule transmission of data of different service types of the terminal device 120 via different downlink control information (downlink control information, DCI). For example, the network device 110 schedules data transmission of a URLLC service type of the terminal device 120 via first DCI, and the network device 110 schedules data transmission of an eMBB service type of the terminal device 120 via second DCI.

When scheduling a plurality of data transmissions of a same service type of the terminal device 120, the network device 110 may schedule the plurality of data transmissions at a time via a same modulation and coding scheme (MCS) table. However, when the terminal device 120 has a requirement of simultaneously transmitting data of a plurality of different service types, the foregoing manner causes a large overall data transmission latency.

Specifically, when the terminal device 120 has a requirement for both data transmission of the URLLC service type and data transmission of the eMBB service type, if the network device 110 needs to schedule a plurality of physical downlink shared channels (PDSCHs) via a plurality of pieces of DCI in the foregoing manner, both DCI overheads and an overall data transmission latency are large. Correspondingly, the terminal device 120 also needs to decode the DCI for a plurality of times, perform channel estimation for a plurality of times, and decode the PDSCH for a plurality of times. Consequently, an overall data processing latency is large.

In view of the foregoing technical problem, this application provides a data transmission method and a communication apparatus, to simultaneously transmit data of a plurality of different service types, thereby reducing an overall data transmission latency.

The following describes the data transmission method and the communication apparatus in embodiments of this application with reference to the accompanying drawings.

FIG. 2 is a schematic interaction flowchart of a data transmission method 200 according to an embodiment of this application. A method procedure in FIG. 2 may be performed by a first communication apparatus and a second communication apparatus, or by modules and/or components (for example, chips or integrated circuits) that are installed in the first communication apparatus and the second communication apparatus and that have corresponding functions. This is not limited in embodiments of this application. The first communication apparatus may be a network device or terminal device, and the second communication apparatus may be a network device or terminal device. Embodiments of this application are applicable to communication between a network device and a terminal device, communication between terminal devices, communication between network devices, communication between other devices, or the like. This is not limited in embodiments of this application. The following uses the first communication apparatus and the second communication apparatus as an example for description. As shown in FIG. 2, the data transmission method 200 includes the following steps.

S210: The second communication apparatus sends first information to the first communication apparatus, where the first information is used to schedule transmission of first data and transmission of second data, the first data corresponds to a first reliability level (reliability level), the second data corresponds to a second reliability level, and the first reliability level is different from the second reliability level.

Correspondingly, the first communication apparatus receives the first information sent by the second communication apparatus, and determines, based on the first information, that the first data and the second data need to be transmitted.

In embodiments of this application, the “transmission” may include sending and receiving. For example, the first communication apparatus determines, based on the first information, that the first data and the second data need to be sent; and/or the first communication apparatus determines, based on the first information, that the first data and the second data need to be received. In a scenario in which sending or receiving is not specifically limited, in this application, the word “transmission” is used to cover the foregoing two scenarios “sending and receiving”. “Sending and receiving” may also be described as “sending and/or receiving”.

That the first data corresponds to a first reliability level may be that a reliability level of the first data is the first reliability level. That the second data corresponds to a second reliability level may be that a reliability level of the second data is the second reliability level. The first reliability level is different from the second reliability level.

When the reliability level corresponds to a service type, the first data and the second data are two pieces of data of different service types. For example, a service type of the first data is a URLLC service type, and a service type of the second data is an eMBB service type. In conclusion, the first data and the second data are two pieces of data that are different in terms of reliability levels or service types.

Optionally, the reliability level may be represented by a bit error rate (bit error rate). For example, a lower bit error rate indicates a higher reliability level. In embodiments of this application, the reliability level is used to represent content or a representation that includes but is not limited to the bit error rate.

For example, the reliability level may be the bit error rate. For example, when reliability indicated by the reliability level is n 9s (that is, 99.999 . . . 9%, n 9s in total), the bit error rate is 1e⁻ⁿ (that is, 0.00 . . . 01, n 0s in total).

Optionally, the reliability level may alternatively be any one of validity, availability, accuracy, integrity, robustness, or scalability. This is not limited in embodiments of this application. For ease of description, in embodiments of this application, the reliability level is used as an example for description, but other optional le or alternative descriptions are not limited.

In embodiments of this application, reliability indicated by the first reliability level (for example, high reliability) may be 99.9999% (a corresponding bit error rate is 1e⁻⁶), 99.99999% (a corresponding bit error rate is 1e⁻⁷), 99.999999% (a corresponding bit error rate is 1e⁻⁸), or the like; and reliability indicated by the second reliability level (for example, medium reliability) may be 99.99% (a corresponding bit error rate is 1e⁻⁴) or 99.999% (a corresponding bit error rate is 1e⁻⁵). The first reliability level may be higher than the second reliability level, or may be lower than the second reliability level. This may be set based on a specific situation. In embodiments of this application, only an example in which the first reliability level is higher than the second reliability level is used for description.

In an optional implementation, the first information may be control information or scheduling information.

For example, the first information is scheduling information configured based on higher layer signaling, or the first information is scheduling information indicated by physical layer signaling.

In an optional implementation, the first information may further indicate the first reliability level and the second reliability level. For example, the second communication apparatus indicates, based on a specific format of the first information, the reliability levels respectively corresponding to the first data and the second data; or the second communication apparatus indicates, based on a specific field in the first information, the reliability levels respectively corresponding to the first data and the second data; or when the reliability levels respectively corresponding to the first data and the second data are predefined in a protocol, the second communication apparatus indicates one or more reliability levels in a plurality of predefined reliability levels based on one or more bits in the first information.

Optionally, a correspondence exists between a format of the first information and the reliability level.

For example, the correspondence between the format of the first information and the reliability level may be at least one row in Table 1. For details, refer to Table 1.

TABLE 1

| Format of the first | | |
|---|---|---|
| information | First reliability level | Second reliability level |
| Format A | Reliability level 1 | Reliability level 2 |
| Format B | Reliability level 2 | Reliability level 3 |
| Format C | Reliability level 1 | Reliability level 3 |
| . . . | . . . | . . . |
| Format N | Reliability level n1 | Reliability level n2 |

The second communication apparatus may indicate two reliability levels based on the format of the first information, and the first communication apparatus may determine the two reliability levels based on the format of the first information. For example, as shown in Table 1, when the format of the first information is A, it indicates that data scheduled via the first information is data of a reliability level 1 (for example, the first reliability level) and data of a reliability level 2 (for example, the second reliability level); when the format of the first information is B, it indicates that data scheduled via the first information is the data of the reliability level 2 (for example, the first reliability level) and data of a reliability level 3 (for example, the second reliability level); and the rest may be deduced by analogy. The first communication apparatus may determine the first reliability level and the second reliability level based on the format of the first information.

Optionally, the second communication apparatus indicates the reliability level via a field of the first information. The first communication apparatus determines the reliability level based on the field of the first information.

For example, four reliability levels are predefined in a protocol, and the four reliability levels have corresponding indexes. For example, an index of a reliability level 1 is 0, an index of a reliability level 2 is 1, an index of a reliability level 3 is 2, and an index of a reliability level 4 is 3. The second communication apparatus may indicate two reliability levels via a bit combination 0001 in the first information. A bit combination 00 indicates the reliability level 1 (for example, the first reliability level), and a bit combination 01 indicates the reliability level 2 (for example, the second reliability level). In this way, the first communication apparatus may determine the first reliability level and the second reliability level based on the bit combination 0001.

Optionally, a reliability level of the data scheduled via the first information is predefined in a protocol. For example, the reliability level of the first data scheduled via the first information is the first reliability level, and the reliability level of the second data is the second reliability level.

In conclusion, the first communication apparatus may determine, based on the first information sent by the second communication apparatus, the first reliability level corresponding to the first data and the second reliability level corresponding to the second data.

S220: The first communication apparatus determines second information, where a first correspondence exists between the second information and both the first reliability level and the second reliability level.

As described above, the first communication apparatus may determine the first reliability level and the second reliability level based on the first information sent by the second communication apparatus, and the first correspondence exists between the second information and both the first reliability level and the second reliability level. Therefore, the first communication apparatus may determine the second information based on the first reliability level, the second reliability level, and the first correspondence. The second information is used for the transmission of the first data and the transmission of the second data.

Optionally, the first correspondence may be predefined in a protocol, or the first correspondence is indicated by the second communication apparatus to the first communication apparatus. This is not limited in embodiments of this application.

In embodiments of this application, that the first correspondence is indicated by the second communication apparatus to the first communication apparatus may be that the second communication apparatus indicates the first correspondence to or configures the first correspondence for the first communication apparatus via signaling. The signaling may be higher layer signaling, physical layer signaling, and/or the like.

Because the second information is used for the transmission of the first data and the transmission of the second data, the second information may include a communication resource, and the communication resource is used for data transmission.

Optionally, the second information may further include information related to data transmission, for example, information about data demodulation, information about data decoding, and information related to feedback for data transmission.

In an optional implementation, the second information may include at least one of the following:
a layer number of a transport block (TB), a time domain resource, a frequency domain resource, a logical channel (LCH), a code block (CB) unit, an MCS table, or an MCS index.

For example, the layer number of the transport block includes a layer number of a first transport block and a layer number of a second transport block, the layer number of the first transport block corresponds to the first reliability level, the layer number of the second transport block corresponds to the second reliability level, the layer number of the first transport block corresponds to the first data, and the layer number of the second transport block corresponds to the second data. The time domain resource includes a first time domain resource and a second time domain resource, the first time domain resource corresponds to the first reliability level, the second time domain resource corresponds to the second reliability level, the first time domain resource corresponds to the first data, and the second time domain resource corresponds to the second data. The frequency domain resource includes a first frequency domain resource and a second frequency domain resource, the first frequency domain resource corresponds to the first reliability level, the second frequency domain resource corresponds to the second reliability level, the first frequency domain resource corresponds to the first data, and the second frequency domain resource corresponds to the second data. The logical channel includes a first logical channel and a second logical channel, the first logical channel corresponds to the first reliability level, the second logical channel corresponds to the second reliability level, the first logical channel corresponds to the first data, and the second logical channel corresponds to the second data. The code block unit includes a first code block unit and a second code block unit, the first code block unit corresponds to the first reliability level, the second code block unit corresponds to the second reliability level, the first code block unit corresponds to the first data, and the second code block unit corresponds to the second data. The MCS table includes a first MCS table and a second MCS table, the first MCS table corresponds to the first reliability level, the second MCS table corresponds to the second reliability level, the first MCS table corresponds to the first data, and the second MCS table corresponds to the second data. The MCS index includes a first MCS index and a second MCS index, the first MCS index corresponds to the first reliability level, the second MCS index corresponds to the second reliability level, the first MCS index corresponds to the first MCS table, the second MCS index corresponds to the second MCS table, the first MCS index corresponds to the first data, and the second MCS index corresponds to the second data. The MCS index indicates one or more rows of parameters in the corresponding MCS table.

Optionally, the layer number of the first transport block may also be expressed as a layer number of the first data, and the layer number of the second transport block may also be expressed as a layer number of the second data.

Each of the foregoing listed parameters may have a correspondence with a reliability level of data. This is further described below.

In an optional implementation, the second information is predefined in a protocol, or the second information is indicated by the second communication apparatus to the first communication apparatus.

For example, when the second information is predefined in the protocol, the first communication apparatus may determine, based on the first reliability level and the second reliability level, communication resources respectively corresponding to the first data and the second data.

For example, when the second information is indicated by the second communication apparatus to the first communication apparatus, the second information may be included in the first information, or may be information independent of the first information. This is not limited in embodiments of this application.

Optionally, the first communication apparatus may determine the second information based on the first reliability level and the second reliability level.

The first communication apparatus may determine, based on the first reliability level and the second reliability level, the communication resources respectively corresponding to the first data and the second data, and transmit the first data and the second data based on the communication resources.

Optionally, the communication resource may be determined based on the second information, or the second information is the foregoing communication resource. This is not limited in embodiments of this application.

In addition, the communication resource is determined by the first communication apparatus based on the first reliability level and the second reliability level, that is, a correspondence exists between the communication resource and both the first reliability level and the second reliability level.

S230: The first communication apparatus transmits the first data and the second data based on the second information.

Specifically, when transmission is sending, the first communication apparatus sends the first data and the second data to the second communication apparatus based on the communication resource corresponding to the second information. When transmission is receiving, the first communication apparatus receives, based on the communication resource corresponding to the second information, the first data and the second data that are sent by the second communication apparatus. When transmission is receiving, the second communication apparatus may also determine the second information, and send the first data and the second data to the first communication apparatus based on the communication resource corresponding to the second information. When transmission is sending, the second communication apparatus may also determine the second information, and receive, based on the communication resource corresponding to the second information, the first data and the second data that are sent by the first communication apparatus.

According to the foregoing technical solution, in this application, data of a plurality of reliability levels can be simultaneously transmitted, and different service types may correspond to different reliability levels. In this way, an overall data transmission latency can be reduced. In addition. This application can further improve overall data transmission efficiency.

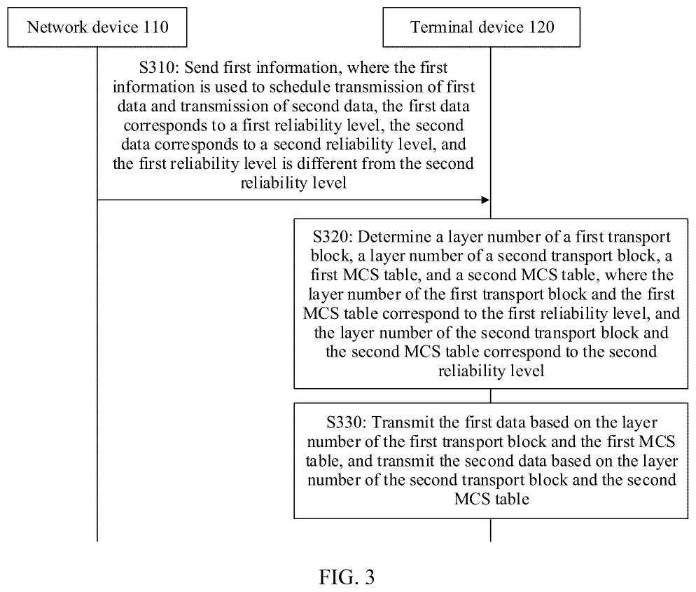

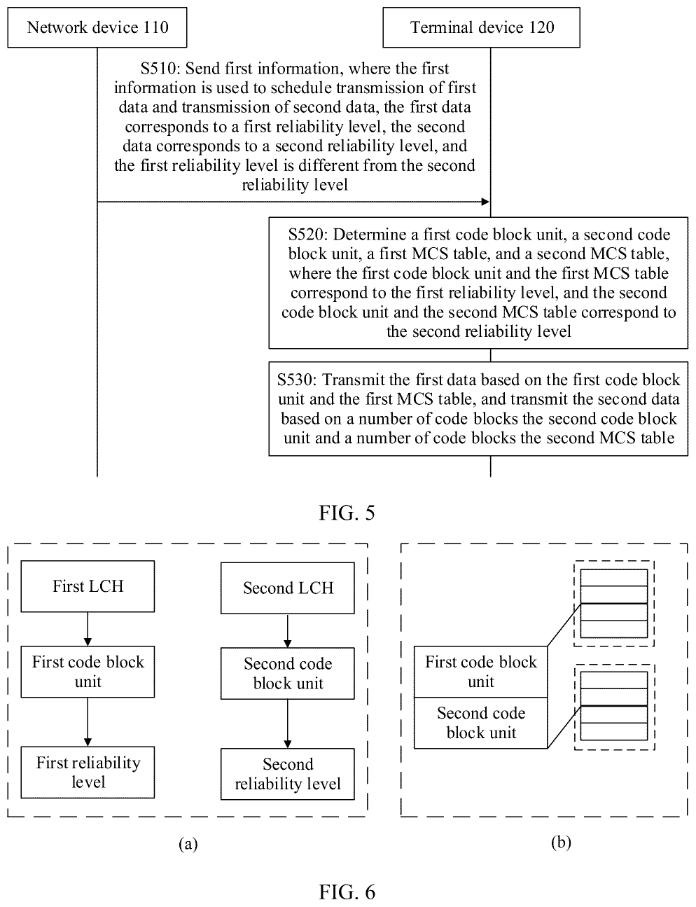

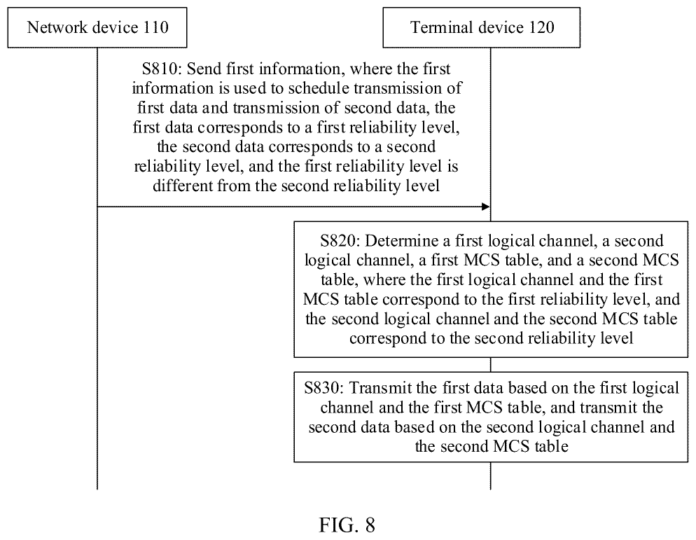

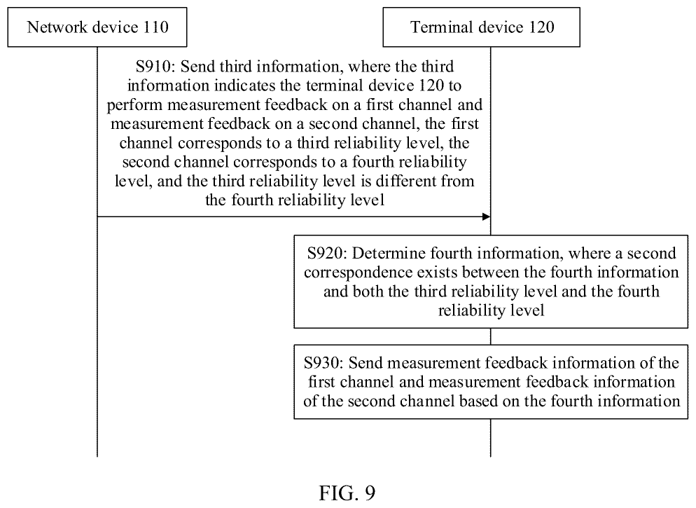

The following further describes the data transmission method 200 shown in FIG. 2 with reference to other accompanying drawings. It should be noted that method procedures in FIG. 3, FIG. 5, FIG. 8, and FIG. 9 may be performed by the terminal device 120 and the network device 110, or may be performed by modules and/or components (for example, chips or integrated circuits) that are installed in the terminal device 120 and the network device 110 and that have corresponding functions. Embodiments of this application are applicable to communication between a network device and a terminal device, or are applicable to communication between terminal devices, or are applicable to communication between network devices, communication between other devices, or the like. This is not limited in embodiments of this application. The following uses the terminal device 120 and the network device 110 as an example for description.

FIG. 3 is a schematic interaction flowchart of a data transmission method 300 according to an embodiment of this application. As shown in FIG. 3, the data transmission method 300 includes the following steps.

S310: The network device 110 sends first information to the terminal device 120, where the first information is used to schedule transmission of first data and transmission of second data, the first data corresponds to a first reliability level, the second data corresponds to a second reliability level, and the first reliability level is different from the second reliability level.

Correspondingly, the terminal device 120 receives the first information from the network device 110.

For specific descriptions, refer to the descriptions of S210. Details are not described herein again.

S320: The terminal device 120 determines a layer number of a first transport block, a layer number of a second transport block, a first MCS table, and a second MCS table, where the layer number of the first transport block and the first MCS table correspond to the first reliability level, and the layer number of the second transport block and the second MCS table correspond to the second reliability level.

Optionally, the transport block may be replaced with any one of a layer group or a codeword. One transport block includes one or more layers (layers). A correspondence exists between the layer number of the first transport block and the first reliability level, and a correspondence exists between the layer number of the second transport block and the second reliability level.

Optionally, the layer number of the first transport block and the first MCS table correspond to the first data, and the layer number of the second transport block and the second MCS table correspond to the second data.

Optionally, a correspondence between a layer number and a reliability level may be predefined in a protocol or indicated by the network device 110 to the terminal device 120.

Specifically, the terminal device 120 may determine the layer number of the first transport block and the layer number of the second transport block in a manner predefined in a protocol. Alternatively, the terminal device 120 may determine the layer number of the first transport block and the layer number of the second transport block in a manner in which the network device 110 indicates the layer number of the first transport block and the layer number of the second transport block to the terminal device 120. This is separately described below.

Determining manners are as follows:
(1) Predefined in the protocol.

The protocol may be a standard protocol in the communication field, for example, may include an LTE protocol, an NR protocol, and a related protocol applied to a communication system evolved after 5G. This is not limited in this application.

It may be predefined in a protocol that different reliability levels correspond to layer numbers of a plurality of transport blocks. Therefore, different reliability levels correspond to different layer numbers of the transport blocks.

For example, it is predefined in a protocol that a first layer in a total layer number corresponds to the first reliability level, and a second layer to an N^{th} layer correspond to the second reliability level. To be specific, the layer number of the first transport block is 1, and the layer number of the second transport block is N−1, where N is a natural number greater than 1.

In an optional implementation, the total layer number may be predefined in a protocol. The network device 110 does not need to indicate the total layer number to the terminal device 120, and the terminal device 120 may determine the layer number of the first transport block and the layer number of the second transport block based on the total layer number. This can reduce signaling overheads.

In an optional implementation, the network device 110 may indicate only the total layer number to the terminal device 120, and the terminal device 120 may determine the layer number of the first transport block and the layer number of the second transport block based on the total layer number and the correspondence between the layer number and the reliability level. This can reduce the signaling overheads.

For example, an association relationship between layer numbers of different transport blocks (reliability levels) and the total layer number is predefined in a protocol. For details, refer to Table 2. The association relationship may be at least one row in Table 2.

TABLE 2

| Total layer | Layer number of the first | Layer number of the second |
|---|---|---|
| number | transport block | transport block |
| 2 | 1 | 1 |
| 3 | 1 | 2 |
| 4 | 1 | 3 |
| 5 | 1 | 4 |
| 6 | 2 | 4 |
| 7 | 2 | 5 |
| 8 | 2 | 6 |

As shown in Table 2, an association relationship exists between the total layer number and both the layer number of the first transport block and the layer number of the second transport block. For example, when the total layer number is 2, the layer number of the first transport block is 1, and the layer number of the second transport block is 1; or when the total layer number is 3, the layer number of the first transport block is 1, and the layer number of the second transport block is 2; or when the total layer number is 4, the layer number of the first transport block is 1, and the layer number of the second transport block is 3. Examples are not enumerated.

In an optional implementation, the network device 110 indicates the total layer number to the terminal device 120, and the terminal device 120 determines the layer number of the first transport block and the layer number of the second transport block based on the total layer number and Table 2. In this way, the signaling overheads can be reduced.

For example, total layer numbers and a layer number division rule of transport blocks at different reliability levels are predefined in a protocol.

For example, it is predefined in a protocol that when the total layer number is less than or equal to 5, the layer number of the first transport block is 1, and a number of remaining layers is the layer number of the second transport block; or when the total layer number is greater than 5, the layer number of the first transport block is 2, and a number of remaining layers is the layer number of the second transport block; or when the total layer number is less than or equal to 3, the layer number of the first transport block is 1, and a number of remaining layers is the layer number of the second transport block; or when the total layer number is greater than or equal to 4, the layer number of the first transport block is 2, and a number of remaining layers is the layer number of the second transport block; or when the total layer number is greater than or equal to 7, the layer number of the first transport block is 3, and a number of remaining layers is the layer number of the second transport block. In this way, the network device 110 indicates the total layer number to the terminal device 120, and the terminal device 120 may determine the layer number of the first transport block and the layer number of the second transport block based on the first reliability level and the second reliability level. This can reduce the signaling overheads.

Optionally, the terminal device 120 may determine the layer number of the first transport block and the layer number of the second transport block according to the predefined layer number division rule.

In an optional implementation, the parameter, that is, the total layer number, may be carried in the first information, or may be carried in other information. This is not limited in embodiments of this application.

Although the foregoing content is described by using the first transport block and the second transport block as an example, the foregoing content may also be applicable to more transport blocks. For a specific method, refer to the foregoing descriptions.
(2) Indicated by the network device 110 to the terminal device 120.

The network device 110 may send indication information #A to the terminal device 120, where the indication information #A indicates the layer number of the first transport block and the layer number of the second transport block. The indication information #A may be the first information, or may be other information. This is not limited in embodiments of this application.

For example, for a format of the indication information #A, refer to Table 3.

TABLE 3
First transport block

| | |
|---|---|
| Layer number (layer number) | One bit or two bits |
| Reliability level | One bit |

Second transport block

| | |
|---|---|
| Layer number | One bit to three bits |
| Reliability level | One bit |

As shown in Table 3, the network device 110 indicates, to the terminal device 120 by using the foregoing format, layer numbers of different transport blocks and reliability levels respectively corresponding to the different transport blocks. For example, the network device 110 indicates the layer number of the first transport block by using the one bit or the two bits, and indicates the reliability level corresponding to the first transport block by using the one bit. The network device 110 indicates the layer number of the second transport block by using the one bit to the three bits, and indicates the reliability level corresponding to the second transport block by using the one bit. In this way, flexibility can be enhanced in a dynamic indication manner.

Optionally, the indication information #A may further include a hybrid automatic repeat request (HARQ) process number (HARQ process number) corresponding to each transport block.

Optionally, the network device 110 may further indicate the layer number of the first transport block and the layer number of the second transport block via radio resource control (radio resource control, RRC) signaling. For example, the network device 110 indicates the layer number (for example, 1 or 2) of the first transport block and the layer number (for example, 1 or 2) of the second transport block to the terminal device 120 via the RRC signaling.

Optionally, the network device 110 may not configure the layer number of the second transport block, and the terminal device 120 may determine the layer number of the second transport block based on the total layer number and the layer number of the first transport block. The network device 110 may also indicate, to the terminal device 120 via the RRC signaling, a layer number (for example, 1 or 2) corresponding to the first reliability level and a layer number (for example, 1 or 2) corresponding to the second reliability level.

Optionally, the network device 110 may not configure the layer number corresponding to the second reliability level, and the terminal device 120 may determine, based on the total layer number and the layer number corresponding to the first reliability level, the layer number corresponding to the second reliability level.

In an optional implementation, a table for layer number division of a plurality of transport blocks is predefined in a protocol, and the network device 110 may send higher layer signaling to the terminal device 120, where the higher layer signaling indicates a layer number division table of a specific transport block. In this way, the network device 110 does not need to perform indication via DCI, so that indication overheads can be reduced. In addition, a layer number division rule of the transport blocks is adjusted in a semi-static manner. This is flexible to some extent.

In an optional implementation, a table for layer number division of a plurality of transport blocks is predefined in a protocol, and the network device 110 may send DCI signaling to the terminal device 120, where the DCI signaling indicates a layer number division table of a specific transport block. The network device 110 merely indicates layer number division table of the specific transport block by using one bit and indicates the total layer number, so that indication overheads can be reduced. In addition, a layer number division rule of the transport blocks is changed in a dynamic change manner. This is flexible to some extent.

After determining the layer number of the first transport block and the layer number of the second transport block in the foregoing manner, the terminal device 120 further needs to determine the first MCS table and the second MCS table. For details, refer to the following descriptions.

Optionally, a plurality of MCS tables are predefined in a protocol, and a correspondence exists between each MCS table and a reliability level. In addition, the plurality of MCS tables predefined in the protocol may be associated with a modulation order capability supported by the terminal device 120 and/or a format of the first information.

For example, if a highest modulation order supported by the terminal device 120 is 64-quadrature amplitude modulation (QAM), the plurality of MCS tables may include QAM64LowSE (corresponding to the first reliability level) and QAM64 (corresponding to the second reliability level); or if a highest modulation order supported by the terminal device 120 is 256 QAM, the plurality of MCS tables may include QAM256LowSE (corresponding to the first reliability level) and QAM256 (corresponding to the second reliability level); or if a highest modulation order supported by the terminal device 120 is 1024 QAM, the plurality of MCS tables may include QAM1024LowSE (corresponding to the first reliability level) and QAM1024 (corresponding to the second reliability level).

For example, the format of the first information may correspond to a plurality of reliability levels. For example, if the format (format) is 0_3 or 1_3, the plurality of MCS tables may include QAM64LowSE (corresponding to the first reliability level and corresponding to the format 0_3) and QAM64 (corresponding to the second reliability level and corresponding to the format 1_3). For example, if the format is 0_4 or 1_4, the plurality of MCS tables may include QAM256LowSE (corresponding to the first reliability level and corresponding to the format 0_4) and QAM256 (corresponding to the second reliability level and corresponding to the format 1_4).

Optionally, the terminal device 120 may determine the first MCS table and the second MCS table based on the format of the first information sent by the network device 110. A form of indicating the MCS table via the format of the first information is similar to that in Table 1. Refer to Table 1. Details are not described herein again.

In an optional implementation, the network device 110 may further send indication information #B to the terminal device 120, where the indication information #B indicates the first MCS table and the second MCS table. The indication information #B may be the first information, or may be other information. This is not limited in embodiments of this application.

For example, for a format of the indication information #B, refer to Table 4.

TABLE 4
First transport block

| | |
|---|---|
| MCS table indication (MCS table indication) | One bit or two bits |
| MCS index | Four bits |

Second transport block

| | |
|---|---|
| MCS table indication | One bit or two bits |
| MCS index | Four bits |

As shown in Table 4, the network device 110 may indicate, to the terminal device 120 by using the foregoing format, MCS tables and MCS indexes that correspond to different transport blocks. For example, the network device 110 indicates, by using the one bit or the two bits, the first MCS table corresponding to the first transport block, and indicates the MCS index of the first MCS table by using the four bits. The MCS index is used to determine one or more corresponding rows in the first MCS table. The network device 110 indicates, by using the one bit or the two bits, the MCS table corresponding to the second transport block, and indicates the MCS index of the second MCS table by using the four bits. The MCS index is used to determine one or more corresponding rows in the second MCS table. In this way, flexibility can be enhanced in a dynamic indication manner.

Optionally, the network device 110 may indicate an MCS table at a transport block level, to be specific, each MCS table one-to-one corresponds to each transport block.

Optionally, the network device 110 may further send a joint index to the terminal device 120, where the joint index indicates both an MCS table and an MCS index. For example, the joint index indicates the first MCS table and the first MCS index. For example, refer to at least one row in Table 5.

TABLE 5

| Joint | MCS | MCS | Modulation | Code rate | Spectral |
|---|---|---|---|---|---|
| index | index | table | order | (CR) | efficiency |
| 0 | 0 | Table 1 | 2 | 30 | 0.0586 |
| 1 | 0 | Table 2 | 2 | 120 | 0.2344 |
| 2 | 1 | Table 1 | 2 | 50 | 0.0977 |
| 3 | 1 | Table 2 | 2 | 251 | 0.4902 |
| 4 | 3 | Table 1 | 4 | 340 | 1.3281 |
| 5 | 4 | Table 2 | 4 | 378 | 1.4766 |
| . . . | . . . | . . . | . . . | . . . | . . . |

As shown in Table 5, when the joint index is 0, it indicates that the first MCS index is 0, the first MCS table is the table 1, the modulation order (modulation order) Q is 2, the CR is 30, and the spectral efficiency is 0.0586; or when the joint index is 1, it indicates that the first MCS index is 0, the first MCS table is the table 2, the modulation order Q is 2, the CR is 120, and the spectral efficiency is 0.2344. Examples are not enumerated. A remaining joint index except the joint indexes 0 to 5 may be used as a reserved option.

Optionally, the network device 110 may further send a joint index to the terminal device 120, where the joint index indicates both an MCS table and an MCS index. For example, the joint index indicates the second MCS table and the second MCS index. For details, refer to at least one row in Table 5-1.

TABLE 5-1

| Joint index | MCS index | MCS table |
|---|---|---|
| 0 | 0 | Table 3 |
| 1 | 0 | Table 4 |
| 2 | 1 | Table 3 |
| 3 | 1 | Table 4 |
| 4 | 3 | Table 3 |
| 5 | 4 | Table 4 |
| . . . | . . . | . . . |

As shown in Table 5-1, when the joint index is 0, it indicates that the second MCS index is 0, and the second MCS table is the table 3; or when the joint index is 1, it indicates that the second MCS index is 0, and the second MCS table is the table 4. Examples are not enumerated. A remaining joint index except the joint indexes 0 to 5 may be used as a reserved option.

Optionally, the network device 110 may further send a joint index to the terminal device 120, where the joint index indicates the first MCS table, the first MCS index, the second MCS table, and the second MCS index. For details, refer to at least one row in Table 5-2.

TABLE 5-2

| Joint | | |
|---|---|---|
| index | MCS index | MCS table |
| 0 | First MCS index i0 and second | Table t0 and table p0 |
| | MCS index j0 | |
| 1 | First MCS index i1 and second | Table t1 and table p1 |
| | MCS index j1 | |
| 2 | First MCS index i2 and second | Table t2 and table p2 |
| | MCS index j2 | |
| 3 | First MCS index i3 and second | Table t3 and table p3 |
| | MCS index j3 | |
| . . . | . . . | . . . |
| n | First MCS index in and second | Table tn and table pn |
| | MCS index jn | |

Herein, i0 to in, j0 to jn, t0 to tn, and p0 to pn are integers.

As shown in Table 5-2, when the joint index is 0, it indicates that the first MCS index is i0, the first MCS table is the table t0, the second MCS index is j0, and the second MCS table is the table p0; when the joint index is 1, it indicates that the first MCS index is i1, the first MCS table is the table t1, the second MCS index is j1, and the second MCS table is the table p1; and the rest may be deduced by analogy. A remaining joint index may be used as a reserved option.

Optionally, the network device 110 may further send a joint index to the terminal device 120, where the joint index indicates the first MCS table, the first MCS index, the second MCS table, and the second MCS index. For details, refer to at least one row in Table 5-3.

TABLE 5-3

| Joint index | MCS index | MCS table |
|---|---|---|
| 0 | 0 and 0 | Table 1 and table 3 |
| 1 | 0 and 1 | Table 1 and table 4 |
| 2 | 1 and 2 | Table 2 and table 3 |
| 3 | 1 and 4 | Table 2 and table 4 |
| 4 | 3 and 3 | Table 2 and table 3 |
| 5 | 4 and 6 | Table 1 and table 4 |
| . . . | . . . | . . . |

As shown in Table 5-3, when the joint index is 0, it indicates that the first MCS index is 0, the first MCS table is the table 1, the second MCS index is 0, and the second MCS table is the table 3; when the joint index is 1, it indicates that the first MCS index is 0, the first MCS table is the table 1, the second MCS index is 1, and the second MCS table is the table 4; when the joint index is 2, it indicates that the first MCS index is 1, the first MCS table is the table 2, the second MCS index is 2, and the second MCS table is the table 3; and the rest may be deduced by analogy. A remaining joint index may be used as a reserved option.

Optionally, Table 5 may not display content such as the Q, the CR, and the spectral efficiency, but displays only content such as the MCS index and the MCS table.

In an optional implementation, when the network device 110 indicates MCS indexes to the terminal device 120, the network device 110 may indicate only one of the MCS indexes, for example, the first MCS index. In addition, there may be a first value between the first MCS index and the second MCS index, and the terminal device 120 may determine the second MCS index based on the first value and the first MCS index. Alternatively, when the network device 110 indicates the second MCS index to the terminal device 120, the terminal device 120 may determine the first MCS index based on the first value and the second MCS index. There may be an association relationship between the first value and a quantity of antennas, a reliability level, or a layer number of a transport block of the terminal device 120.

Optionally, the first value may be predefined in a protocol, or may be notified by the network device 110 to the terminal device 120 via signaling. This is not limited in this application.

Optionally, the terminal device 120 determines the second MCS index based on the first MCS index and the first value. For example, the network device 110 indicates that the first MCS index is 100. When a value of the first value is −4, the terminal device 120 may determine, based on the first MCS index and the first value, that the second MCS index is 962.

In an optional implementation, when the network device 110 indicates indexes of MCS tables to the terminal device 120, the network device 110 may indicate an index of only one of the MCS tables, for example, the index of the first MCS table. In addition, there may be a second value between the index of the first MCS table and the index of the second MCS table, and the terminal device 120 may determine the index of the second MCS table based on the second value and the index of the first MCS table. Alternatively, when the network device 110 indicates the index of the second MCS table to the terminal device 120, the terminal device 120 may determine the index of the first MCS table based on the second value and the index of the second MCS table.

Optionally, the second value may be predefined in a protocol, or may be notified by the network device 110 to the terminal device 120 via signaling. This is not specifically limited in this application.

Optionally, the terminal device 120 determines the index of the second MCS table based on the index of the first MCS table and the second value. For example, the network device 110 indicates that the index of the first MCS table is 100. When a value of the second value is 2, the terminal device 120 may determine, based on the index of the first MCS table and the second value, that the index of the second MCS table is 102.

Optionally, the network device 110 may indicate the first MCS index and the second MCS index to the terminal device 120.

According to the foregoing technical solution, the terminal device 120 may implement joint indication of the MCS table and the MCS index via the second information, and determine the plurality of MCS tables, to meet transmission requirements of different services, reduce signaling overheads, and improve communication performance.

For example, for data whose signal-to-noise ratio (SNR) of a first transport layer of the terminal device 120 is −1 dB and whose transmission reliability is e⁻⁵, the network device 110 indicates that the first MCS index is 8. For data whose SNR of a second transport layer of the terminal device 120 is −3 dB and whose transmission reliability is e⁻¹, the network device 110 indicates that the second MCS index is 3 (the first value is equal to −5).

For example, the terminal device 120 determines the second MCS index based on the first MCS index and the first value. For example, for data whose SNR of the first/second transport layer of the terminal device 120 is 2 dB and whose transmission reliability is e⁻⁵, the network device 110 indicates that the first MCS index of the first MCS table is 12. For data whose SNR of a third transport layer of the terminal device 120 is −4 dB and whose transmission reliability is e⁻¹, the network device 110 indicates that the second MCS index is 2 (the first value is equal to −10).

Optionally, the network device 110 may indicate the first MCS table and the second MCS table to the terminal device 120. For example, the network device 110 may indicate the MCS table by using the format of the first information. Refer to Table 6-1.

TABLE 6-1

| format 0 1 | Table 1 and Table 2 |
|---|---|
| format 0_2 | QAM64LowSE and QAM64 |
| format 0_3 | QAM64LowSE and QAM256 |
| format 0_4 | QAM256LowSE and QAM1024 |

As shown in Table 6-1, for example, when the format of the first information is format 0_1, format 0_1 may indicate the table 1 and the table 2. When the format of the first information is format 0 2, format 0_2 may indicate the QAM64LowSE and QAM64. When the format of the first information is format 0_3, format 0_3 may indicate QAM64LowSE and QAM256. When the format of the first information is format 0_4, format 0_4 may indicate QAM256LowSE and QAM1024. Each table corresponds to one reliability level.

Optionally, the network device 110 may indicate the reliability level to the terminal device 120. For example, the network device 110 may indicate the reliability level by using the format of the first information. Refer to Table 6-2.

TABLE 6-2

| | |
|---|---|
| format 0_1 | Reliability level 1 and reliability level 2 |
| format 0_2 | Reliability level 2 and reliability level 3 |
| format 0_3 | Reliability level 1 and reliability level 3 |

As shown in Table 6-2, for example, when the format of the first information is format 0_1, format 0_1 may indicate the reliability level 1 of the first data and the reliability level 2 of the second data. When the format of the first information is format 0_2, format 0_2 may indicate the reliability level 2 of the first data and the reliability level 3 of the second data. When the format of the first information is format 0_3, format 0_3 may indicate the reliability level 1 of the first data and the reliability level 3 of the second data.

In an optional implementation, the plurality of MCS tables are predefined in the protocol, and the network device 110 sends higher layer signaling to the terminal device 120 to indicate the first MCS table and the second MCS table in the plurality of MCS tables. In this way, the network device 110 does not need to perform indication via DCI, so that indication overheads can be reduced. In addition, a rule for the MCS table is adjusted in a semi-static manner. This is flexible to some extent.

In an optional implementation, the plurality of MCS tables are predefined in the protocol, and the network device 110 sends DCI signaling to the terminal device 120 to indicate the first MCS table and the second MCS table in the plurality of MCS tables. In this way, the network device 110 indicates the first MCS table and the second MCS table by using only one or two bits, so that indication overheads can be reduced. In addition, a rule for the MCS table is changed in a dynamic change manner. This is flexible to some extent.

In an optional implementation, the network device 110 sends higher layer signaling to the terminal device 120, where the higher layer signaling indicates the plurality of MCS tables. Then, the network device 110 sends DCI signaling to the terminal device 120, where the DCI signaling indicates the first MCS table and the second MCS table in the plurality of MCS tables. In this way, the network device 110 indicates the first MCS table and the second MCS table by using only one or two bits, so that indication overheads can be reduced. In addition, a rule for the MCS table is changed in a dynamic change manner. This is flexible to some extent.

In an optional implementation, the network device 110 may alternatively indicate the MCS table and the MCS index to the terminal device 120 by using a single index or a plurality of indexes, for example, a first index indicating the first MCS table and the first MCS index, a second index indicating the second MCS table and the second MCS index, a third index indicating the first MCS index and the second MCS index, a fourth index indicating the first MCS table and the second MCS table, a fifth index indicating the first MCS table, a sixth index indicating the first MCS index, a seventh index indicating the second MCS table, an eighth index indicating the second MCS index, or a ninth index indicating the first MCS table, the first MCS index, the second MCS table, and the second MCS index.

For example, when the network device 110 indicates the first index to the terminal device 120, the terminal device 120 may determine the index of the second MCS table and the second MCS index based on the first value and the second value. Similarly, when the network device 110 indicates the fifth index and the sixth index to the terminal device 120, the terminal device 120 may determine the seventh index and the eighth index based on the first value and the second value.

S330: The terminal device 120 transmits the first data based on the layer number of the first transport block and the first MCS table, and transmits the second data based on the layer number of the second transport block and the second MCS table.

After determining the layer numbers of the transport blocks and the MCS tables that respectively correspond to the reliability levels, the terminal device 120 may transmit the data based on the layer numbers of the transport blocks and the MCS tables. For descriptions of transmission, refer to the foregoing descriptions. Details are not described herein again.

According to the foregoing technical solution, in this application, matched layer numbers of transport blocks and matched MCS tables can be configured for data of different service types (or reliability levels), to support simultaneous transmission of a plurality of pieces of data. In this way, an overall data transmission latency can be reduced, and data transmission efficiency can be improved.

Specifically, a plurality of pieces of data with different reliability are transmitted in one time of data scheduling, so that spatial multiplexing of the data with the different reliability can be implemented. In addition, the data transmission latency can be reduced, and spatial multiplexing efficiency and communication performance can be improved.

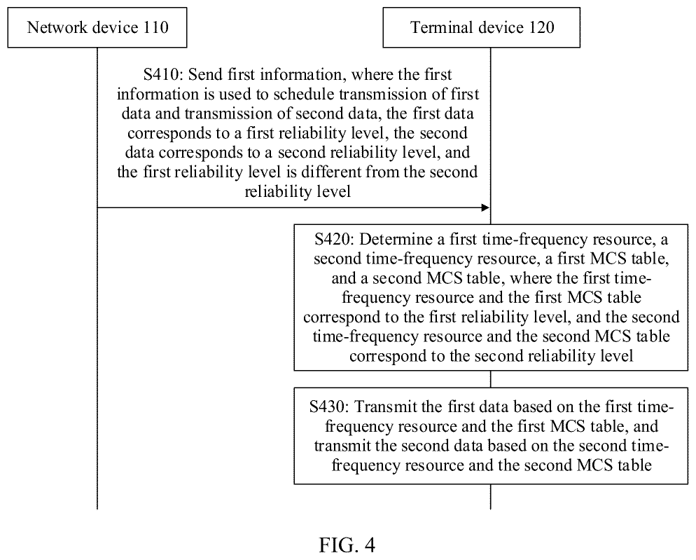

FIG. 4 is a schematic interaction flowchart of a data transmission method 400 according to an embodiment of this application. As shown in FIG. 4, the data transmission method 400 includes the following steps.

S410: The network device 110 sends first information to the terminal device 120, where the first information is used to schedule transmission of first data and transmission of second data, the first data corresponds to a first reliability level, the second data corresponds to a second reliability level, and the first reliability level is different from the second reliability level.

Correspondingly, the terminal device 120 receives the first information from the network device 110.

For specific descriptions, refer to the descriptions of S210. Details are not described herein again.

S420: The terminal device 120 determines a first time-frequency resource, a second time-frequency resource, a first MCS table, and a second MCS table, where the first time-frequency resource and the first MCS table correspond to the first reliability level, and the second time-frequency resource and the second MCS table correspond to the second reliability level.

Optionally, the first time-frequency resource and the first MCS table correspond to the first data, and the second time-frequency resource and the second MCS table correspond to the second data.

Specifically, the terminal device 120 may determine the first time-frequency resource and the second time-frequency resource in a manner predefined in a protocol, or the terminal device 120 may determine the first time-frequency resource and the second time-frequency resource in a manner in which the network device 110 indicates the first time-frequency resource and the second time-frequency resource to the terminal device 120.

For example, the terminal device 120 performs selection from a plurality of time-frequency resources predefined in a protocol based on the first reliability level and the second reliability level, to determine the first time-frequency resource corresponding to the first reliability level and the second time-frequency resource corresponding to the second reliability level.

For example, the network device 110 may further indicate, to the terminal device 120, the first time-frequency resource corresponding to the first reliability level and the second time-frequency resource corresponding to the second reliability level. For a specific manner, refer to the foregoing descriptions in which the network device 110 indicates the layer numbers of the transport blocks to the terminal device 120. Details are not described herein again.

For a manner in which the terminal device 120 determines the first MCS table and the second MCS table in S420, refer to the foregoing description in which the terminal device 120 determines the first MCS table and the second MCS table in S320. Details are not described herein again.

In this embodiment of this application, the first MCS table and the second MCS table may be the same or may be different.

Optionally, when the first data and the second data are transmitted by using different codewords and/or different layers, for example, for multi-codeword or multi-layer transmission in the method 300, a time-frequency resource may be determined for each layer group and/or codeword. In this way, time division and/or frequency division transmission of data of different codewords and/or layer groups can be implemented. In other words, the first data and the second data may correspond to different time-frequency resources.

S430: The terminal device 120 transmits the first data based on the first time-frequency resource and the first MCS table, and transmits the second data based on the second time-frequency resource and the second MCS table.

The time-frequency resource may include a time domain resource and a frequency domain resource. In a scenario in which whether a resource is a time domain resource or a frequency domain resource is not clearly described, the foregoing two types are summarized by using the time-frequency resource in this application. However, method descriptions of the time-frequency resource are also applicable to descriptions of the time domain resource and the frequency domain resource.

After determining a time-frequency resource and an MCS table that correspond to each reliability level, the terminal device 120 may transmit data based on the time-frequency resource and the MCS table. For descriptions of transmission, refer to the foregoing descriptions. Details are not described herein again.

According to the foregoing technical solution, in this application, matched time-frequency resources and matched MCS tables can be configured for data of different service types (or reliability levels), to support simultaneous transmission of a plurality of pieces of data. In this way, an overall data transmission latency can be reduced, and data transmission efficiency can be improved.

Specifically, a plurality of pieces of data with different reliability are transmitted in one time of data scheduling. This can implement time division/frequency division multiplexing of the data with the different reliability. In addition, the data transmission latency can be reduced, and time division/frequency division multiplexing efficiency and communication performance can be further improved.

In an optional implementation, the method 400 shown in FIG. 4 may be further combined with the method 300 shown in FIG. 3. To be specific, after or before determining the layer number of the first transport block and the layer number of the second transport block, the terminal device 120 may further determine the corresponding first time-frequency resource and the corresponding second time-frequency resource, and transmit the first data based on the layer number of the first transport block, the first time-frequency resource, and the first MCS table, and transmit the second data based on the layer number of the second transport block, the second time-frequency resource, and the second MCS table. In this way, spatial multiplexing and time-frequency multiplexing efficiency can also be implemented, and transmission of data of a plurality of service types can also be supported.

FIG. 5 is a schematic interaction flowchart of a data transmission method 500 according to an embodiment of this application. As shown in FIG. 5, the data transmission method 500 includes the following steps.

S510: The network device 110 sends first information to the terminal device 120, where the first information is used to schedule transmission of first data and transmission of second data, the first data corresponds to a first reliability level, the second data corresponds to a second reliability level, and the first reliability level is different from the second reliability level.

Correspondingly, the terminal device 120 receives the first information from the network device 110.

For specific descriptions, refer to the descriptions of S210. Details are not described herein again.

S520: The terminal device 120 determines a first code block unit, a second code block unit, a first MCS table, and a second MCS table, where the first code block unit and the first MCS table correspond to the first reliability level, and the second code block unit and the second MCS table correspond to the second reliability level.

In this embodiment of this application, the first MCS table and the second MCS table may be the same or may be different.

FIG. 6 shows a correspondence between a code block unit, a logical channel, and a reliability level. As shown in (a) in FIG. 6, a first LCH is mapped to the first code block unit, and a correspondence exists between the first LCH, the first code block unit, and the first reliability level; and a second LCH is mapped to the second code block unit, and a correspondence exists between the second LCH, the second code block unit, and the second reliability level. As shown in (b) in FIG. 6, the first code block unit may include a plurality of code blocks, and the second code block unit may also include a plurality of code blocks. A specific number may be determined according to the foregoing method. (b) in FIG. 6 further shows independence of the code block unit. In this way, each code block unit may be processed or mapped.

Based on a mapping relationship between a code block unit and an LCH, in this embodiment of this application, the logical channel can be properly allocated for transmission, to meet transmission requirements of different logical channels. Different logical channels correspond to different code block units, and independent code block unit processing may be performed, to meet requirements of different services as required, and improve communication performance.

Optionally, when the first data and the second data are transmitted via different code block units, a time-frequency resource may be determined for each code block unit, so that time division and/or frequency division transmission of the different code block units can be implemented. In other words, the first data and the second data may correspond to different time-frequency resources.

In this embodiment of this application, the LCH is not mapped across code block units, and the code block unit is bound to the LCH. For example, the first LCH corresponds to the first code block unit, and the first code block unit corresponds to the first reliability level; and the second LCH corresponds to the second code block unit, and the second code block unit corresponds to the second reliability level.

In addition, a mapping rule between the LCH and the code block unit may include:
1: first mapping an LCH corresponding to a high reliability level; and
2: skipping performing bit interleaving across LCHs.

Zero padding processing may be performed on an insufficient bit part in the code block unit.

Specifically, the terminal device 120 may determine the first code block unit and the second code block unit in a manner predefined in a protocol, or the terminal device 120 may determine the first code block unit and the second code block unit in a manner in which the network device 110 indicates the first code block unit and the second code block unit to the terminal device 120. This is separately described below.

In this embodiment of this application, one code block unit may include one CB, or may include a plurality of code blocks (which may be a code block group (CBG)).

For descriptions of the code block unit (for example, content such as predefined in the protocol or indication by the network device 110 to the terminal device 120), refer to the descriptions of the layer numbers of the transport blocks. Details are not described herein again.

S530: The terminal device 120 transmits the first data based on a number of code blocks in the first code block unit and the first MCS table, and transmits the second data based on a number of code blocks in the second code block unit and the second MCS table.

After determining a number of code blocks in a code block unit and an MCS table that correspond to each reliability level, the terminal device 120 may transmit data based on the number of code blocks in the code block unit and the MCS table. For descriptions of transmission, refer to the foregoing descriptions. Details are not described herein again.

According to the foregoing technical solution, in this application, matched numbers of code blocks in code block units and matched MCS tables can be configured for data of different service types (or reliability levels), to support simultaneous transmission of a plurality of pieces of data. In this way, an overall data transmission latency can be reduced, and data transmission efficiency can be improved.

Specifically, a plurality of pieces of data with different reliability are transmitted in one time of data scheduling. This can implement code division multiplexing of the data with the different reliability. In addition, the data transmission latency can be reduced, and code division multiplexing efficiency and communication performance can be improved.

It should be understood that a correspondence exists between the code block unit and the LCH described above. For example, the first code block unit corresponds to the first LCH, and the second code block unit corresponds to the second LCH. In other words, the logical channel needs to be mapped to the code block unit.

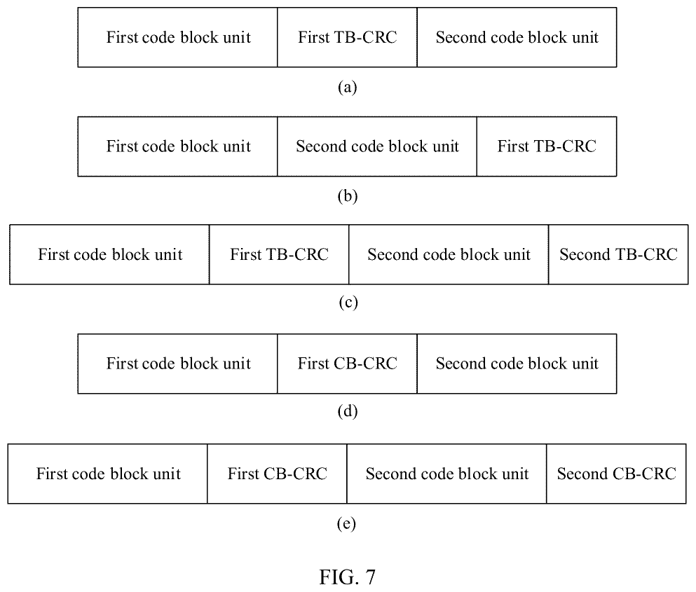

In the method 500 shown in FIG. 5, the first code block unit and the second code block unit belong to a third transport block. To verify correctness of each code block unit and the third transport block, a cyclic redundancy check (CRC) usually needs to be attached to the end of each code block unit. To implement fast decoding of the first data and the second data, CRCs of the first code block unit and the second code block unit may be set in at least one of the following manners. For example, FIG. 7 shows a correspondence between a code block unit and a cyclic redundancy check. For details, refer to the following descriptions.

Manner 1: The first code block unit includes a first TB-CRC, and the second code block unit does not include the first TB-CRC. For example, as shown in (a) in FIG. 7, the first TB-CRC may be placed after the first code block unit.

When the first code block unit and the second code block unit form a transport block, the transport block may include a first TB-CRC to verify whether the transport block is successfully decoded.

In this manner, the first TB-CRC may be included in a bit of the first code block unit, and is used to check a first transport block, so that fast decoding can be implemented. For the second code block unit, the first transport block does not need to be checked, and transport-block-based hybrid automatic repeat request (HARQ) feedback can be implemented. This reduces feedback bit overheads.

Manner 2: The first code block unit does not include a first TB-CRC, and the second code block unit includes the first TB-CRC. For example, as shown in (b) in FIG. 7, the first TB-CRC may be placed after the second code block unit.

When the first code block unit and the second code block unit form a transport block, the transport block may include a first TB-CRC to verify whether the transport block is successfully decoded.

In this manner, the first TB-CRC may be included in a bit of the second code block unit, and is used to check a first transport block, so that fast decoding can be implemented. For the first code block unit, the first transport block does not need to be checked, and transport-block-based HARQ feedback can be implemented. This reduces feedback bit overheads.

Manner 3: The first code block unit includes a first TB-CRC, and the second code block unit includes a second TB-CRC. For example, as shown in (c) in FIG. 7, the first TB-CRC may be placed after the first code block unit, and the second TB-CRC may be placed after the second code block unit.

When the first code block unit forms a transport block, the transport block may include a first TB-CRC to verify whether the transport block is successfully decoded. When the second code block unit forms another transport block, the transport block may include a second TB-CRC to verify whether the transport block is successfully decoded.

In this manner, the first TB-CRC is used to check a first transport block, so that fast decoding can be implemented. To be specific, whether the first code block unit is successfully received can be determined without waiting for decoding of the second code block unit. This reduces a latency. The second TB-CRC is used to check a second transport block, so that a code block unit can be quickly decoded. In addition, transport block check is performed, so that transport-block-based HARQ feedback can be implemented. This reduces feedback bit overheads.

Manner 4: The first code block unit includes a first CB-CRC, and the second code block unit does not include the first CB-CRC. For example, as shown in (d) in FIG. 7, the first CB-CRC may be placed after the first code block unit.

When the first code block unit includes one or more code blocks, each code block may include a first CB-CRC to verify whether the code block is successfully decoded. When the second code block unit includes another code block, the code block does not need to include the first CB-CRC. This reduces transmission bit overheads.

In this manner, the first CB-CRC is used to check a first code block, so that fast decoding can be implemented. To be specific, whether the first code block unit is successfully received can be determined without waiting for decoding of the second code block unit. This reduces a latency. In addition, transport block check is performed, so that transport-block-based HARQ feedback can be implemented. This reduces feedback bit overheads.

Manner 5: The first code block unit includes a first CB-CRC, and the second code block unit includes a second CB-CRC. For example, as shown in (e) in FIG. 7, the first CB-CRC may be placed after the first code block unit, and the second CB-CRC may be placed after the second code block unit.

When the first code block unit includes one or more code blocks, each code block may include a first CB-CRC to verify whether the code block is successfully decoded. When the second code block unit includes another code block, the code block may include a second CB-CRC to verify whether the code block is successfully decoded.

In this manner, the first CB-CRC is used to check a first code block, so that fast decoding can be implemented. To be specific, whether the first code block unit is successfully received can be determined without waiting for decoding of the second code block unit. This reduces a latency. The second CB-CRC is used to check a second code block, so that a code block unit can be quickly decoded. In addition, code block check is performed, so that code-block-based HARQ feedback can be implemented. This improves retransmission efficiency.

FIG. 8 is a schematic interaction flowchart of a data transmission method 800 according to an embodiment of this application. As shown in FIG. 8, the data transmission method 800 includes the following steps.

S810: The network device 110 sends first information to the terminal device 120, where the first information is used to schedule transmission of first data and transmission of second data, the first data corresponds to a first reliability level, the second data corresponds to a second reliability level, and the first reliability level is different from the second reliability level.

Correspondingly, the terminal device 120 receives the first information from the network device 110.

For specific descriptions, refer to the descriptions of S210. Details are not described herein again.

S820: The terminal device 120 determines a first logical channel, a second logical channel, a first MCS table, and a second MCS table, where the first logical channel and the first MCS table correspond to the first reliability level, and the second logical channel and the second MCS table correspond to the second reliability level.

In this embodiment of this application, the first MCS table and the second MCS table may be the same or may be different.

Specifically, the terminal device 120 may determine the first logical channel and the second logical channel in a manner predefined in a protocol, or the terminal device 120 may determine the first logical channel and the second logical channel in a manner in which the network device 110 indicates the first logical channel and the second logical channel to the terminal device 120.

For example, the terminal device 120 performs selection from a plurality of logical channels predefined in a protocol based on the first reliability level and the second reliability level, to determine the first logical channel corresponding to the first reliability level and the second logical channel corresponding to the second reliability level.

For example, the network device 110 may further indicate, to the terminal device 120, the first logical channel corresponding to the first reliability level and the second logical channel corresponding to the second reliability level. For a specific manner, refer to the foregoing descriptions in which the network device 110 indicates the layer numbers of the transport blocks to the terminal device 120. Details are not described herein again.

For a manner in which the terminal device 120 determines the first MCS table and the second MCS table in S820, refer to the foregoing description in which the terminal device 120 determines the first MCS table and the second MCS table in S320. Details are not described herein again.

S830: The terminal device 120 transmits the first data based on the first logical channel and the first MCS table, and transmits the second data based on the second logical channel and the second MCS table.

After determining a logical channel and an MCS table that correspond to each reliability level, the terminal device 120 may transmit data based on the logical channel and the MCS table. For descriptions of transmission, refer to the foregoing descriptions. Details are not described herein again.

According to the foregoing technical solution, in this application, matched logical channels and matched MCS tables can be configured for data of different service types (or reliability levels), to support simultaneous transmission of a plurality of pieces of data. In this way, an overall data transmission latency can be reduced, and data transmission efficiency can be improved.

FIG. 9 is a schematic interaction flowchart of a data transmission method 900 according to an embodiment of this application. As shown in FIG. 9, the data transmission method 900 includes the following steps.

S910: The network device 110 sends third information to the terminal device 120, where the third information indicates the terminal device 120 to perform measurement feedback on a first channel and measurement feedback on a second channel, the first channel corresponds to a third reliability level, and the second channel corresponds to a fourth reliability level.

Correspondingly, the terminal device 120 receives the third information from the network device 110, and can determine, based on the third information, that the measurement feedback on the first channel and the measurement feedback on the second channel need to be performed. The first channel corresponds to the third reliability level, and the second channel corresponds to the fourth reliability level.

That the first channel corresponds to a third reliability level may be that a reliability level of the first channel is the third reliability level. That the second channel corresponds to a fourth reliability level may be that a reliability level of the second channel is the fourth reliability level. The third reliability level is different from the fourth reliability level. For descriptions of reliability levels, refer to the foregoing content. Details are not described herein again.

Optionally, the third reliability level may alternatively be a first reliability level, and the fourth reliability level may alternatively be a second reliability level. This is not limited in this application.

In an optional implementation, the third information may be channel measurement feedback configuration information, and the configuration information indicates the terminal device 120 to perform a “multi-layer reliability measurement feedback mode”, a “multi-reliability mode”, or a “multi-bit error rate mode”. When measuring channel state information (CSI) based on the indication, the terminal device 120 performs measurement and feedback in a multi-layer reliability measurement feedback manner.

In an optional implementation, the third information may further indicate the third reliability level corresponding to the first channel and the fourth reliability level corresponding to the second channel. For the descriptions, refer to the foregoing related content that the first information may indicate the first reliability level and the second reliability level. Details are not described herein again.

In conclusion, the terminal device 120 may determine, based on the third information sent by the network device 110, the third reliability level corresponding to the first channel and the fourth reliability level corresponding to the second channel.

S920: The terminal device 120 determines fourth information, where a second correspondence exists between the fourth information and both the third reliability level and the fourth reliability level.

As described above, the terminal device 120 may determine the third reliability level and the fourth reliability level based on the third information sent by the network device 110, and the second correspondence exists between the fourth information and both the third reliability level and the fourth reliability level. Therefore, the terminal device 120 may determine the fourth information based on the third reliability level, the fourth reliability level, and the second correspondence. The fourth information may be used to transmit measurement feedback information of the first channel and measurement feedback information of the second channel.

Optionally, the second correspondence may be predefined in a protocol, or the second correspondence is indicated by the network device 110 to the terminal device 120. This is not limited in embodiments of this application.

Because the fourth information is used to transmit the measurement feedback information of the first channel and the measurement feedback information of the second channel, the fourth information may include a communication resource, and the communication resource is used to transmit measurement feedback information of a channel.

In an optional implementation, the fourth information may include at least one of the following:
a layer number of a transport block, a channel quality indicator (CQI) table, or a signal-to-noise ratio threshold.

For example, the layer number of the transport block includes a layer number of a fourth transport block and a layer number of a fifth transport block, the layer number of the fourth transport block corresponds to the third reliability level, and the layer number of the fifth transport block corresponds to the fourth reliability level. The CQI table includes a first CQI table and a second CQI table, the first CQI table corresponds to the third reliability level, and the second CQI table corresponds to the fourth reliability level.

Each of the foregoing listed parameters may have a correspondence with a reliability level of a channel. This is further described below.

According to the foregoing technical solution, the terminal device 120 may determine the fourth information based on the reliability levels, to determine layer numbers, CQI tables, and/or signal-to-noise ratio thresholds at different reliability levels, meet service transmission with different reliability requirements, implement channel measurement feedback with different requirements, and improve communication performance.

In an optional implementation, the fourth information is predefined in a protocol, or the fourth information is indicated by the network device 110 to the terminal device 120.

For example, when the fourth information is predefined in the protocol, the terminal device 120 may determine, based on the third reliability level and the fourth reliability level, communication resources respectively corresponding to the first channel and the second channel. For example, when the fourth information is indicated by the network device 110 to the terminal device 120, the fourth information may be included in the third information, or may be information independent of the third information. This is not limited in embodiments of this application.

Optionally, the terminal device 120 may determine the fourth information based on the third reliability level and the fourth reliability level.

The terminal device 120 may determine, based on the third reliability level and the fourth reliability level, the communication resources respectively corresponding to the third reliability level and the fourth reliability level, and transmit the measurement feedback information of the first channel and the measurement feedback information of the second channel based on the communication resources.

In addition, the signal-to-noise ratio threshold may be used to determine the layer number of the fourth transport block and the layer number of the fifth transport block. For details, refer to the following descriptions.

In an optional implementation, the signal-to-noise ratio threshold is predefined in a protocol, or the signal-to-noise ratio threshold is indicated by the network device 110 to the terminal device 120. This is further described below.
(1) Predefined in the protocol.

Association relationships between different signal-to-noise ratio thresholds and layer numbers of different transport blocks may be predefined in a protocol.

For example, it is predefined in a protocol that when an SNR of a transport layer in a total layer number is greater than or equal to the SNR threshold, the transport layer belongs to the fourth transport block and corresponds to the first CQI table; or when an SNR of a transport layer is less than the SNR threshold, the transport layer belongs to the fifth transport block and corresponds to the second CQI table. For example, the SNR threshold is 10 dB. If an SNR of each transport layer in the first three layers in the total layer number is greater than or equal to 10 dB, and an SNR of each transport layer in the last five layers is less than 10 dB, the first three transport layers belong to the fourth transport block, and the last five transport layers belong to the fifth transport block.

Optionally, association relationships between different SNR thresholds and different reliability levels are predefined in a protocol. For details, refer to at least one row in Table 9-1. A correspondence may be the at least one row in the table 9-1:

TABLE 9-1

| SNR threshold | Reliability level |
|---|---|
| ≥u1 (or >u1) | Reliability level 1 |
| <u1 and ≥u2 (or >u2) | Reliability level 2 |
| <u2 (or ≤u2) | Reliability level 3 |

Herein, u1 is a real number, for example, 5, 10, or 20.

As shown in Table 9-1, when an SNR of a transport layer is greater than or equal to the SNR threshold, the transport layer corresponds to the reliability level 1, that is, the transport layer belongs to the fourth transport block; or when an SNR of a transport layer is less than the SNR threshold, the transport layer corresponds to the reliability level 2, that is, the transport layer belongs to the fifth transport block.

For a specific example, refer to at least one row in Table 9-2. A correspondence may be the at least one row in the table 9-2:

TABLE 9-2

| SNR threshold | Reliability level |
|---|---|
| ≥10 | Reliability level 1 |
| <10 | Reliability level 2 |

As shown in Table 9-2, when an SNR of a transport layer is greater than or equal to the SNR threshold, the transport layer corresponds to the reliability level 1, that is, the transport layer belongs to the fourth transport block; or when an SNR of a transport layer is less than the SNR threshold, the transport layer corresponds to the reliability level 2, that is, the transport layer belongs to the fifth transport block.
(2) Indicated by the network device 110 to the terminal device 120.

The network device 110 may send indication information #D to the terminal device 120, where the indication information #D indicates the SNR threshold. The indication information #D may be the third information, or may be other information. This is not limited in embodiments of this application.

Optionally, the network device 110 may further indicate the SNR threshold to the terminal device 120 via RRC signaling. The terminal device 120 may determine a correspondence between each layer in the total layer number and a reliability level based on the SNR threshold.

Optionally, the network device 110 may further indicate, to the terminal device 120 via the RRC signaling, a layer number corresponding to the third reliability level. For example, if the network device 110 indicates that the layer number corresponding to the third reliability level is 2, feedback of the terminal device 120 for a first layer and a second layer in the total layer number corresponds to the first CQI table, and feedback of the terminal device 120 for a transport layer other than the first transport layer and the second transport layer in the total layer number corresponds to the second CQI table.

Optionally, the network device 110 may further indicate, to the terminal device 120, a maximum layer number and an SNR threshold that correspond to the third reliability level. For example, if the network device 110 indicates that the layer number corresponding to the third reliability level is 2, and the SNR threshold is 10, for SNRs of the first transport layer and the second transport layer in the total layer number, when the SNRs of the first transport layer and the second transport layer are greater than or equal to the SNR threshold, the feedback for the first transport layer and the feedback for the second transport layer correspond to the first CQI table, and the feedback for the layer other than the first transport layer and the second transport layer in the total layer number corresponds to the second CQI table; or when the SNR of the first transport layer is greater than or equal to the SNR threshold, and the SNR of the second transport layer is less than the SNR threshold, the feedback for the first transport layer corresponds to the first CQI table, and the feedback for the layer other than the first transport layer in the total layer number corresponds to the second CQI table.

After determining the layer number of the fourth transport block and the layer number of the fifth transport block in the foregoing manner, the terminal device 120 further needs to determine the first CQI table and the second CQI table. For details, refer to the following descriptions.

In an optional implementation, a plurality of CQI tables are predefined in a protocol, and a correspondence exists between each CQI table and a reliability level. The terminal device 120 may determine corresponding CQI tables based on different reliability levels.

In an optional implementation, the reliability level and an index of the CQI table may be predefined in a protocol. For details, refer to at least one row in Table 10-1.

TABLE 10-1

| Reliability level | CQI table |
|---|---|
| Reliability level A | CQI table A |
| Reliability level B | CQI table B |

As shown in Table 10-1, if a transport layer corresponds to the reliability level A, a CQI feedback for the layer corresponds to the CQI table A; or if a transport layer corresponds to the reliability level B, a CQI feedback for the layer corresponds to the CQI table B.

In an optional implementation, both the SNR threshold and the index of the CQI table may be predefined in a protocol. For details, refer to at least one row in Table 10-2.

TABLE 10-2

| SNR threshold | Reliability level | CQI table |
|---|---|---|
| ≥10 | Reliability level a | CQI table a |
| <10 | Reliability level b | CQI table b |

As shown in Table 10-2, if an SNR of a transport layer is greater than or equal to the SNR threshold, the transport layer corresponds to the reliability level a and corresponds to the CQI table a; or if an SNR of a transport layer is less than the SNR threshold, the transport layer corresponds to the reliability level b and corresponds to the CQI table b.

Optionally, the terminal device 120 may determine a first CQI table and a second CQI table based on a format of the third information sent by the network device 110.

In an optional implementation, the network device 110 may further send indication information #E to the terminal device 120, where the indication information #E indicates the first CQI table and the second CQI table. The indication information #E may be the third information, or may be other information. This is not limited in embodiments of this application.

For example, the network device 110 indicates the plurality of CQI tables in the third information. A first SNR threshold corresponds to the first CQI table, a second SNR threshold corresponds to the second CQI table, a third SNR threshold corresponds to a third CQI table, and the other SNR thresholds follow the same rule.

Optionally, the network device 110 may further indicate a plurality of reliability levels in the third information. For example, a reliability level 1 (or a bit error rate) corresponds to e⁻⁸, a reliability level 2 (or a bit error rate) corresponds to e⁻⁶, and a reliability level 3 (or a bit error rate) corresponds to e⁻¹ (when the third information does not indicate a reliability level, the reliability level is 3 by default).

Optionally, when one reliability level corresponds to a plurality of CQI tables, the reliability level and the corresponding CQI tables may be further indicated. For example, a reliability level 1 corresponds to both a CQI table 1-1 (64 QAM) and a CQI table 1-2 (256 QAM); a reliability level 2 corresponds to both a CQI table 2-1 (256 QAM) and a CQI table 2-2 (1024 QAM); and a reliability level 3 corresponds to both a CQI table 3-1 (64 QAM) and a CQI Table 3-2 (256 QAM).

Optionally, the network device 110 may indicate the SNR threshold to the terminal device 120 via higher layer signaling.

Optionally, the network device 110 may indicate the layer number to the terminal device 120 via higher layer signaling.

Optionally, the network device 110 may indicate a maximum layer number of the transport block and the SNR threshold to the terminal device 120 via higher layer signaling.

Optionally, the SNR threshold is predefined in a protocol, and the network device 110 may indicate the maximum layer number to the terminal device 120.

Optionally, the maximum layer number of the transport block is predefined in a protocol, and the network device 110 may indicate the SNR threshold to the terminal device 120.

S930: The terminal device 120 sends the measurement feedback information of the first channel and the measurement feedback information of the second channel based on the fourth information.

After determining the layer numbers of the transport blocks and the CQI tables that respectively correspond to the reliability levels, the terminal device 120 may transmit the measurement feedback information of the channels based on the layer numbers of the transport blocks and the CQI tables.

According to the foregoing technical solution, in this application, matched layer numbers of transport blocks and matched CQI tables can be configured for channel measurement feedback for the plurality of reliability levels, to support simultaneous transmission of a plurality of pieces of data. In this way, an overall data transmission latency can be reduced, and data transmission efficiency can be improved.

Specifically, a plurality of pieces of data of different reliability are transmitted in one time of data scheduling, which can meet CQI feedback under different reliability level requirements, and can improve communication performance.

In this embodiment of this application, the method shown in FIG. 9 may be combined with the method shown in FIG. 2. For example, before transmitting the first data and the second data, the terminal device 120 may first perform channel measurement feedback, to determine a matching channel. Alternatively, after transmitting the first data and the second data, the terminal device 120 may send the measurement feedback information of the channel. In this way, the network device 110 selects, for the terminal device 120, a proper channel that matches the reliability level.

It should be noted that, in this embodiment of this application, an example in which the terminal device 120 determines the second information or the fourth information is used for description. However, the description or the technical solution is also applicable to determining the second information or the fourth information by the network device 110. For example, the network device 110 determines the second information, and transmits the first data and the second data based on the second information. For another example, the network device 110 determines the fourth information, and receives the measurement feedback information of the first channel and the measurement feedback information of the second channel based on the fourth information. For ease of brevity, content about how the network device 110 determines the second information or the fourth information is not described again. For details, refer to the descriptions about how the terminal device 120 determines the second information or the fourth information.

The channel measurement feedback described above may be performed based on a CSI-reference signal (RS), or may be performed based on a demodulation reference signal (DMRS), a PDSCH, or the like. This is not limited in embodiments of this application.

It should be noted that, when the technical solution shown in FIG. 9 is combined with the technical solution shown in FIG. 2, the third reliability level may be the same as the first reliability level, and the fourth reliability level may also be the same as the second reliability level.

Optionally, the third reliability level may be different from the first reliability level, and the fourth reliability level may also be different from the second reliability level. This specifically depends on a requirement, and is not limited in embodiments of this application.

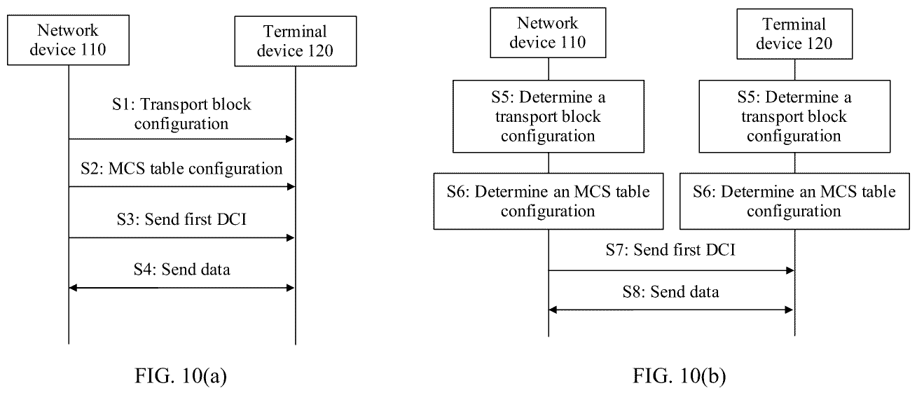

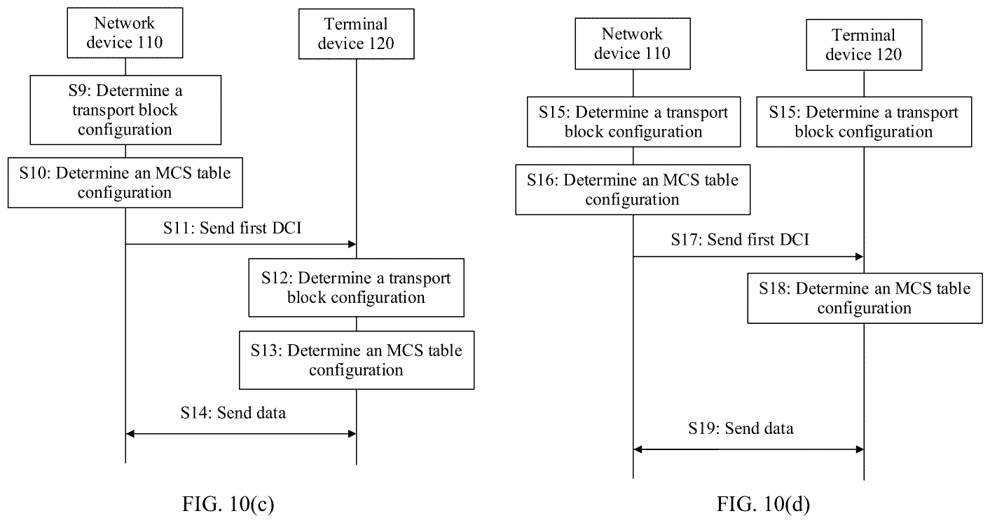

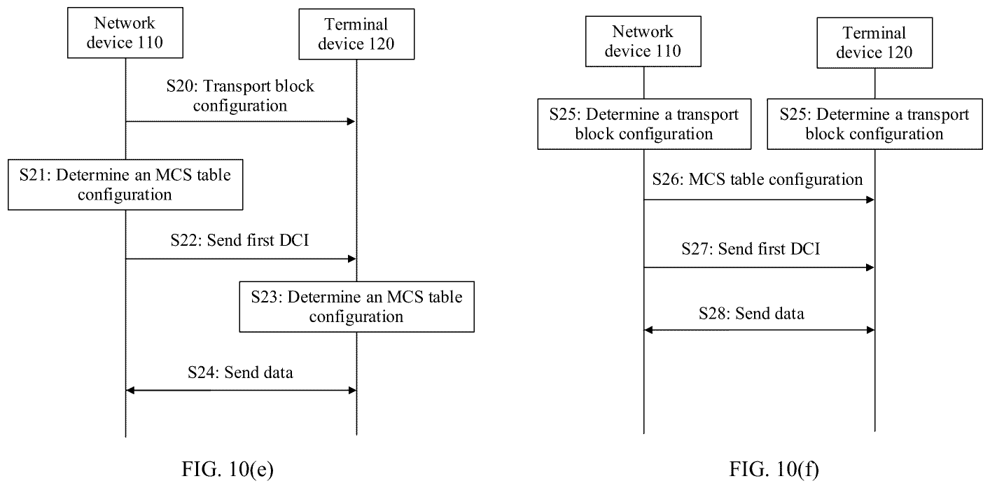

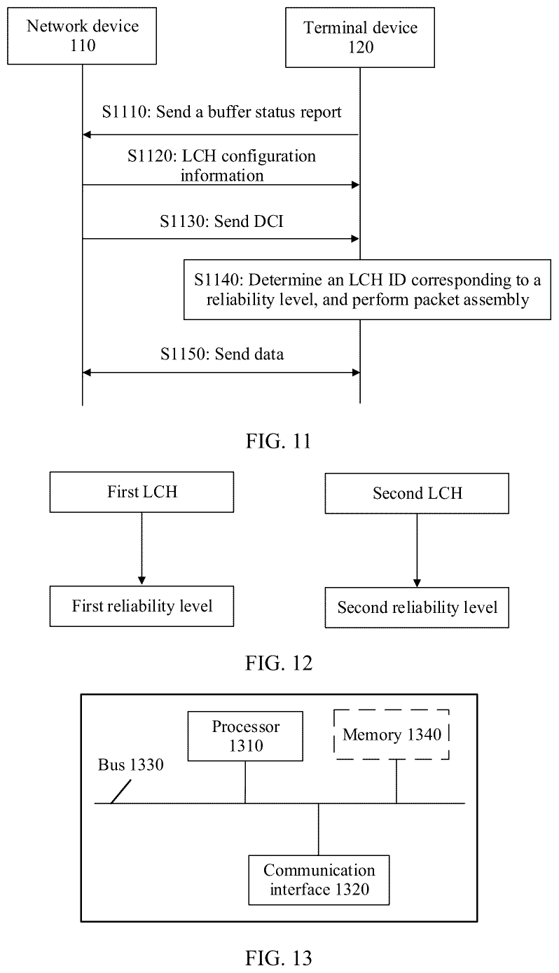

The following further describes the foregoing method with reference to FIG. 10(a) to FIG. 10(f) and FIG. 11.

FIG. 10(a) to FIG. 10(f) are a schematic interaction flowchart of a data transmission method 1000 according to an embodiment of this application. The solution shown in FIG. 10(a) to FIG. 10(f) is a further description of the method shown in FIG. 3, and communication may be performed in at least one manner in FIG. 10(a) to FIG. 10(f).

In FIG. 10(a), the network device 110 indicates a transport block configuration and an MCS table configuration to the terminal device 120 (via higher layer signaling), and schedules, via DCI signaling, data transmission corresponding to a plurality of reliability levels. An example is as follows:

S1: The network device 110 sends first RRC signaling to the terminal device 120, where the first RRC signaling indicates the transport block configuration.

S2: The network device 110 sends second RRC signaling to the terminal device 120, where the second RRC signaling indicates the MCS table configuration.

S3: The network device 110 sends first DCI signaling to the terminal device 120, where the first DCI signaling is used to schedule the data transmission corresponding to the plurality of reliability levels.

S4: The network device 110 performs data transmission (which is bidirectional data transmission, and for related descriptions, refer to the foregoing descriptions) with the terminal device 120.

A sequence of steps S1 and S2 is not limited, and steps S1 and S2 may be performed simultaneously. The first RRC signaling and the second RRC signaling may be same RRC signaling, or may be different RRC signaling. This is not limited in this application.

In FIG. 10(b), a transport block configuration and an MCS table configuration are predefined in a protocol, and the network device 110 schedules, via DCI signaling, data transmission corresponding to a plurality of reliability levels. An example is as follows:

S5: The network device 110 and the terminal device 120 determine the transport block configuration (predefined in the protocol).

S6: The network device 110 and the terminal device 120 determine the MCS table configuration (predefined in the protocol).

S7: The network device 110 sends first DCI signaling to the terminal device 120, where the first DCI signaling is used to schedule the data transmission corresponding to the plurality of reliability levels.

S8: The network device 110 performs data transmission with the terminal device 120.

A sequence of steps S5 and S6 is not limited, and steps S5 and S6 may be performed simultaneously. This is not limited in this application.

In FIG. 10(c), the network device 110 indicates a transport block configuration and an MCS table configuration to the terminal device 120 (via physical layer signaling), and the network device 110 schedules, via DCI signaling, data transmission corresponding to a plurality of reliability levels. An example is as follows:

S9: The network device 110 determines the transport block configuration, and sends second DCI signaling to the terminal device to indicate the transport block configuration.

S10: The network device 110 determines the MCS table configuration, and sends third DCI signaling to the terminal device to indicate the MCS table configuration.

S11: The network device 110 sends first DCI signaling to the terminal device 120, where the first DCI signaling is used to schedule the data transmission corresponding to the plurality of reliability levels.

S12: The terminal device 120 determines the transport block configuration (indicated by the network device 110).

S13: The terminal device 120 determines the MCS table configuration (indicated by the network device 110).

S14: The network device 110 performs data transmission with the terminal device 120.

A sequence of step S9 and step S10 is not limited. The first DCI signaling, the second DCI signaling, and the third DCI signaling may be same DCI signaling, or may be different DCI signaling. This is not limited in this application.

In FIG. 10(d), a transport block configuration is predefined in a protocol, the network device 110 indicates an MCS table configuration to the terminal device (via physical layer signaling), and the network device 110 schedules, via DCI signaling, data transmission corresponding to a plurality of reliability levels. An example is as follows:

S15: The network device 110 and the terminal device 120 determine the transport block configuration (predefined in the protocol).

S16: The network device 110 determines the MCS table configuration, and sends fourth DCI signaling to the terminal device to indicate the MCS table configuration.

S17: The network device 110 sends first DCI signaling to the terminal device 120, where the first DCI signaling is used to schedule the data transmission corresponding to the plurality of reliability levels.

S18: The terminal device 120 determines the MCS table configuration (indicated by the network device 110).

S19: The network device 110 performs data transmission with the terminal device 120.

A sequence of step S15 and step S16 is not limited. The fourth DCI signaling and the first DCI signaling may be same DCI signaling, or may be different DCI signaling. This is not limited in this application.

In FIG. 10(e), the network device 110 indicates a transport block configuration to the terminal device 120 (via higher layer signaling), the network device 110 indicates an MCS table configuration to the terminal device 120 (via physical layer signaling), and schedules, via DCI signaling, data transmission corresponding to a plurality of reliability levels. An example is as follows:

S20: The network device 110 sends first RRC signaling to the terminal device 120, where the first RRC signaling indicates the transport block configuration.

S21: The network device 110 determines the MCS table configuration, and sends fifth DCI signaling to the terminal device.

S22: The network device 110 sends first DCI signaling to the terminal device 120, where the first DCI signaling is used to schedule the data transmission corresponding to the plurality of reliability levels.

S23: The terminal device 120 determines the MCS table configuration (indicated by the network device 110).

S24: The network device 110 performs data transmission with the terminal device 120.

A sequence of step S20 and step S21 is not limited. The fifth DCI signaling and the first DCI signaling may be same DCI signaling, or may be different DCI signaling. This is not limited in this application.

In FIG. 10(f), a transport block configuration is predefined in a protocol, the network device 110 indicates an MCS table configuration to the terminal device 120 (via higher layer signaling), and the network device 110 schedules, via DCI signaling, data transmission corresponding to a plurality of reliability levels. An example is as follows:

S25: The network device 110 and the terminal device 120 determine the transport block configuration (predefined in the protocol).

S26: The network device 110 sends second RRC signaling to the terminal device 120, where the second RRC signaling indicates the MCS table configuration.

S27: The network device 110 sends first DCI signaling to the terminal device 120, where the first DCI signaling is used to schedule the data transmission corresponding to the plurality of reliability levels.

S28: The network device 110 performs data transmission with the terminal device 120.

A sequence of step S25 and step S26 is not limited.

The solution shown in FIG. 10(a) to FIG. 10(f) further describes how the second information in FIG. 3 is indicated. For example, the second information mentioned above may be predefined in a protocol, or may be indicated by the network device 110. FIG. 10(a) to FIG. 10(f) specifically describe a solution predefined or indicated in a protocol. For other content not described in FIG. 10(a) to FIG. 10(f), refer to the content in FIG. 3. Details are not described herein again.

It should be understood that the content shown in FIG. 10(a) to FIG. 10(f) is a description of a transport block, but the content shown in FIG. 10(a) to FIG. 10(f) is also applicable to descriptions of a code block unit. The code block unit is not described herein again. For the descriptions of the code block unit, refer to the foregoing descriptions of the layer number of the transport block.

FIG. 11 is a schematic interaction flowchart of a data transmission method 1100 according to an embodiment of this application. The solution shown in FIG. 11 is a further description of the method shown in FIG. 8. For other content not described in FIG. 11, refer to the content in FIG. 8. Details are not described herein again. The method includes the following steps.

S1110: The terminal device 120 sends a buffer status report (BSR) to the network device 110.

Correspondingly, the network device 110 receives the BSR sent by the terminal device 120.

S1120: The network device 110 sends LCH configuration information to the terminal device 120.

Correspondingly, the terminal device 120 receives the LCH configuration information sent by the network device 110, and determines, based on the LCH configuration information, an LCH configured by the network device 110 for the terminal device 120.

Optionally, the LCH configuration information may include an MCS table list (allowedMcsTable-List), where the MCS table list indicates that data transmission on different LCHs corresponds to different MCS tables.

Optionally, the LCH configuration information may further include a reliability level list (reliabilitylevel-List), where the reliability level list indicates that data transmission on different LCHs corresponds to different reliability levels.

S1130: The network device 110 sends DCI to the terminal device 120, where the DCI indicates a reliability level.

Correspondingly, the terminal device 120 receives the DCI sent by the network device 110, and determines, based on the DCI, a reliability level corresponding to data.

Specifically, the DCI indicates that first data corresponds to a first reliability level, and second data corresponds to a second reliability level.

S1140: The terminal device 120 determines an LCH ID corresponding to the reliability level, and performs packet assembly.

Specifically, the terminal device 120 determines, based on the received LCH configuration information and the received DCI, that data on a first logical channel corresponds to the first reliability level and data on a second logical channel corresponds to the second reliability level. Therefore, the terminal device 120 may perform corresponding packet assembly. Packet assembly refers to adding information such as a start identifier and a length to a specified data packet.

S1150: The terminal device 120 sends data to the network device 110.

Specifically, the data sent by the terminal device 120 to the network device 110 corresponds to the LCH ID. To be specific, the data on the LCH 1 corresponds to an MCS table 1 (or a reliability level 1), and the data on the LCH 2 corresponds to an MCS table 2 (or a reliability level 2).

When receiving the DCI information, the terminal device 120 may determine data transmitted on an LCH based on an MCS table (or a reliability level) indicated in the DCI information. For example, if the DCI information indicates the MCS table 1 and the MCS table 2, the terminal device 120 transmits the data on the LCH 1 based on an indication of the MCS table 1, and transmits the data on the LCH 2 based on an indication of the MCS table 2.

In addition, FIG. 12 shows a correspondence between an LCH and a reliability level. As shown in FIG. 12, the first LCH corresponds to the first reliability level, and the second LCH corresponds to the second reliability level.

When receiving scheduling information (for example, RxCI), the terminal device 120 determines data transmitted on an LCH based on a reliability level indicated in the scheduling information. For example, if the scheduling information indicates the first reliability level and the second reliability level, the terminal device 120 transmits the data on the first LCH based on an indication of the first reliability level, and transmits the data on the second LCH based on an indication of the second reliability level.

The foregoing describes the method embodiments in embodiments of this application, and the following describes corresponding apparatus embodiments.

To implement the functions in the methods provided in embodiments of this application, both the terminal and the network device may include a hardware structure and/or a software module, and implement the functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

FIG. 13 is a block diagram of a communication apparatus 1300 according to an embodiment of this application. The communication apparatus 1300 includes a processor 1310 and a communication interface 1320. The processor 1310 and the communication interface 1320 may be connected to each other through a bus 1330. The communication apparatus 1300 shown in FIG. 13 may be a network device, or may be a terminal device.

Optionally, the communication apparatus 1300 further includes a memory 1340.

The memory 1340 includes but is not limited to a random access memory (RAM), a read-only memory (ROM), an erasable programmable read-only memory (EPROM), or a compact disc read-only memory (CD-ROM). The memory 1340 is configured to store related instructions and data.

The processor 1310 may be one or more central processing units (CPUs). When the processor 1310 is a CPU, the CPU may be a single-core CPU or a multi-core CPU.

When the communication apparatus 1300 is the terminal device 120, for example, the processor 1310 in the communication apparatus 1300 is configured to perform the following operations: receiving first information, where the first information is used to schedule transmission of first data and transmission of second data, the first data corresponds to a first reliability level, the second data corresponds to a second reliability level, and the first reliability level is different from the second reliability level; determining second information, where a first correspondence exists between the second information and both the first reliability level and the second reliability level; and transmitting the first data and the second data based on the second information.

For another example, the processor 1310 in the communication apparatus may perform the following operations: receiving third information, where the third information indicates the communication apparatus to perform measurement feedback on a first channel and measurement feedback on a second channel, the first channel corresponds to a third reliability level, and the second channel corresponds to a fourth reliability level; determining fourth information, where a second correspondence exists between the fourth information and both the third reliability level and the fourth reliability level; and sending measurement feedback information of the first channel and measurement feedback information of the second channel based on the fourth information.

The foregoing content is merely used as an example for description. When the communication apparatus 1300 is the terminal device 120, the communication apparatus 1300 is responsible for performing the methods or steps related to the terminal device 120 in the foregoing method embodiments.

When the communication apparatus 1300 is the network device 110, for example, the processor 1310 in the communication apparatus 1300 is configured to perform the following operations: sending first information, where the first information is used to schedule transmission of first data and transmission of second data, the first data corresponds to a first reliability level, the second data corresponds to a second reliability level, and the first reliability level is different from the second reliability level; determining second information, where a first correspondence exists between the second information and both the first reliability level and the second reliability level; and transmitting the first data and the second data based on the second information.

For another example, the processor 1310 in the communication apparatus 1300 may perform the following operations: sending third information, where the third information indicates a first communication apparatus to perform measurement feedback on a first channel and measurement feedback on a second channel, the first channel corresponds to a third reliability level, and the second channel corresponds to a fourth reliability level; determining fourth information, where a second correspondence exists between the fourth information and both the third reliability level and the fourth reliability level; and receiving measurement feedback information of the first channel and measurement feedback information of the second channel based on the fourth information.

The foregoing content is merely used as an example for description. When the communication apparatus 1300 is the network device 110, the communication apparatus 1300 is responsible for performing the methods or steps related to the network device 110 in the foregoing method embodiments.

The foregoing description is merely an example for description. For specific content, refer to the content shown in the foregoing method embodiments. In addition, for implementation of each operation in FIG. 13, refer to corresponding descriptions in the method embodiments shown in FIG. 2 to FIG. 12.

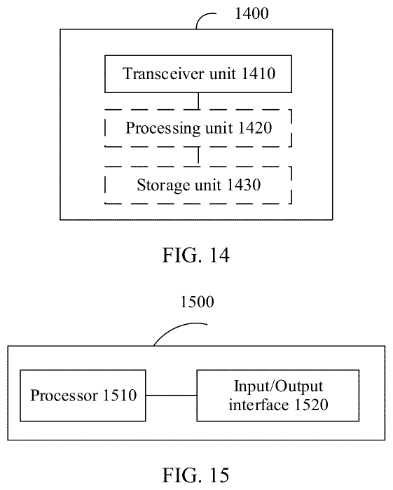

FIG. 14 is a block diagram of a communication apparatus 1400 according to an embodiment of this application. The communication apparatus 1400 may be the network device or the terminal device in the foregoing embodiments, or may be a chip or a module in the network device or the terminal device, and is configured to implement the methods in the foregoing embodiments. The communication apparatus 1400 includes a transceiver unit 1410. The following describes the transceiver unit 1410 by using an example.

The transceiver unit 1410 may include a sending unit and a receiving unit that are respectively configured to implement a sending function and a receiving function in the foregoing method embodiments; and may further include a processing unit, configured to implement a function other than the sending function or the receiving function.

When the communication apparatus 1400 is the terminal device 120, for example, the transceiver unit 1410 is configured to receive first information, where the first information is used to schedule transmission of first data and transmission of second data, the first data corresponds to a first reliability level, the second data corresponds to a second reliability level, and the first reliability level is different from the second reliability level. The transceiver unit 1410 is further configured to transmit the first data and the second data based on second information.

Optionally, the communication apparatus 1400 may further include a processing unit 1420, configured to perform content related to steps such as processing and coordination of the terminal device 120. For example, the processing unit 1420 is configured to determine the second information, where a first correspondence exists between the second information and both the first reliability level and the second reliability level.

Optionally, the communication apparatus 1400 further includes a storage unit 1430. The storage unit 1430 is configured to store a program or code used to perform the foregoing method.

The foregoing content is merely used as an example for description. When the communication apparatus 1400 is the terminal device 120, the communication apparatus 1400 is responsible for performing the methods or steps related to the terminal device 120 in the foregoing method embodiments.

When the communication apparatus 1400 is the network device 110, for example, the transceiver unit 1410 is configured to send first information, where the first information is used to schedule transmission of first data and transmission of second data, the first data corresponds to a first reliability level, the second data corresponds to a second reliability level, and the first reliability level is different from the second reliability level. The transceiver unit 1410 is further configured to transmit the first data and the second data based on second information.

Optionally, the communication apparatus 1400 may further include a processing unit 1420, configured to perform content related to steps such as processing and coordination of the network device 110. For example, the processing unit 1420 is configured to determine the second information, where a first correspondence exists between the second information and both the first reliability level and the second reliability level.

Optionally, the communication apparatus 1400 further includes a storage unit 1430. The storage unit 1430 is configured to store a program or code used to perform the foregoing method.

The foregoing content is merely used as an example for description. When the communication apparatus 1400 is the network device 110, the communication apparatus 1400 is responsible for performing the methods or steps related to the network device 110 in the foregoing method embodiments.

The foregoing content is merely used as an example for description. When the communication apparatus 1400 is the terminal device 120, the communication apparatus 1400 is responsible for performing the methods or steps related to the terminal device 120 in the foregoing method embodiments.

In addition, for implementation of each operation in FIG. 14, refer to corresponding descriptions of the method shown in the foregoing embodiments. Details are not described herein again.

The apparatus embodiments shown in FIG. 13 and FIG. 14 are used to implement the content described in the method embodiments FIG. 2 to FIG. 12. Therefore, for specific execution steps and methods of the apparatuses shown in FIG. 13 and FIG. 14, refer to the content described in the foregoing method embodiments.

It should be understood that the transceiver unit may include the sending unit and the receiving unit. The sending unit is configured to perform a sending action of the communication apparatus, and the receiving unit is configured to perform a receiving action of the communication apparatus. For ease of description, in embodiments of this application, the sending unit and the receiving unit are combined into one transceiver unit. Unified descriptions are provided herein, and details are not described below.

FIG. 15 is a diagram of a communication apparatus 1500 according to an embodiment of this application. The communication apparatus 1500 may be configured to implement functions of the network device and the terminal device in the foregoing method. The communication apparatus 1500 may be a chip in the network device or the terminal device.

The communication apparatus 1500 includes an input/output interface 1520 and a processor 1510. The input/output interface 1520 may be an input/output circuit. The processor 1510 may be a signal processor, a chip, or another integrated circuit that can implement the method in this application. The input/output interface 1520 is configured to input or output a signal or data.

For example, when the communication apparatus 1500 is the terminal device 120, the input/output interface 1520 is configured to receive first information, where the first information is used to schedule transmission of first data and transmission of second data, the first data corresponds to a first reliability level, the second data corresponds to a second reliability level, and the first reliability level is different from the second reliability level. The processor 1510 is configured to perform a part or all of steps of any one of the methods provided in embodiments of this application.

For example, when the communication apparatus 1500 is the network device 110, the input/output interface 1520 is configured to send first information, where the first information is used to schedule transmission of first data and transmission of second data, the first data corresponds to a first reliability level, the second data corresponds to a second reliability level, and the first reliability level is different from the second reliability level. The processor 1510 is configured to perform a part or all of steps of any one of the methods provided in embodiments of this application.

In an optional implementation, the processor 1510 executes instructions stored in a memory, to implement a function implemented by the network device or the terminal device.

Optionally, the communication apparatus 1500 further includes the memory.

Optionally, the processor and the memory are integrated together.

Optionally, the memory is outside the communication apparatus 1500.

In an optional implementation, the processor 1510 may be a logic circuit, and the processor 1510 inputs/outputs a message or signaling through the input/output interface 1520. The logic circuit may be a signal processor, a chip, or another integrated circuit that can implement the methods in embodiments of this application.

The foregoing description of the apparatus in FIG. 15 is merely an example for description. The apparatus can be configured to perform the methods in the foregoing embodiments. For specific content, refer to the descriptions in the foregoing method embodiments. Details are not described herein again.

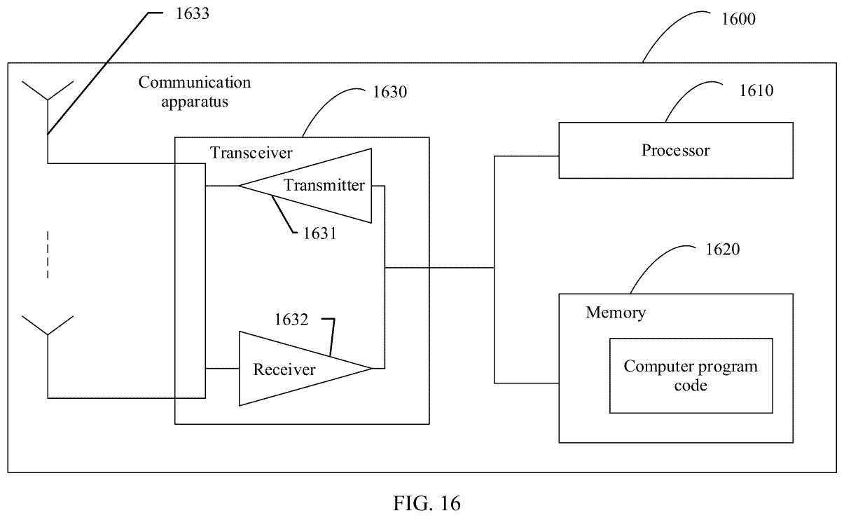

FIG. 16 is a block diagram of a communication apparatus 1600 according to an embodiment of this application. The communication apparatus 1600 may be a network device or a chip. The communication apparatus 1600 may be configured to perform the operations performed by the network device in the method embodiments shown in FIG. 2 to FIG. 12.

When the communication apparatus 1600 is a network device, for example, a base station, FIG. 16 is a diagram of a simplified structure of a base station. The base station includes a part 1610, a part 1620, and a part 1630. The part 1610 is mainly configured to perform baseband processing, control the base station, and the like. The part 1610 is usually a control center of the base station, may be usually referred to as a processor, and is configured to control the base station to perform a processing operation on a network device side in the foregoing method embodiments. The part 1620 is mainly configured to store computer program code and data. The part 1630 is mainly configured to receive/send a radio frequency signal, and perform conversion between the radio frequency signal and a baseband signal. The part 1630 may be usually referred to as a transceiver module, a transceiver, a transceiver circuit, a transceiver machine, or the like. A transceiver module in the part 1630 may also be referred to as a transceiver machine, a transceiver, or the like, and includes an antenna 1633 and a radio frequency circuit (not shown in the figure). The radio frequency circuit is mainly configured to perform radio frequency processing. Optionally, a component configured to implement a receiving function in the part 1630 may be considered as a receiver, and a component configured to implement a sending function may be considered as a transmitter. In other words, the part 1630 includes a receiver 1632 and a transmitter 1631. The receiver may also be referred to as a receiving module, a receiver machine, a receiver circuit, or the like, and the transmitter may be referred to as a transmitting module, a transmitter machine, a transmitter circuit, or the like.

The part 1610 and the part 1620 may include one or more boards, and each board may include one or more processors and one or more memories. The processor is configured to read and execute a program in the memory, to implement a baseband processing function and control the base station. If there are a plurality of boards, the boards may be interconnected with each other to enhance a processing capability. In an optional implementation, a plurality of boards may share one or more processors, or a plurality of boards share one or more memories, or a plurality of boards share one or more processors at the same time.

For example, in an implementation, the transceiver module in the part 1630 is configured to perform a receiving and sending-related process performed by the network device in the embodiments shown in FIG. 2 to FIG. 12. A processor in the part 1610 is configured to perform a processing-related process performed by the network device in the embodiments shown in FIG. 2 to FIG. 12.

In another implementation, a processor in the part 1610 is configured to perform a processing-related process performed by a communication device in the embodiments shown in FIG. 2 to FIG. 2.

In another implementation, the transceiver module in the part 1630 is configured to perform a receiving and sending-related process performed by a communication device in the embodiments shown in FIG. 2 to FIG. 12.

It should be understood that FIG. 16 is merely an example rather than a limitation. The network device including the processor, the memory, and the transceiver may not depend on the structures shown in FIG. 13 to FIG. 15.

When the communication apparatus 1600 is a chip, the chip includes a transceiver, a memory, and a processor. The transceiver may be an input/output circuit or a communication interface. The processor is a processor, a microprocessor, or an integrated circuit integrated on the chip. A sending operation performed by the network device in the foregoing method embodiments may be understood as output of the chip, and a receiving operation performed by the network device in the foregoing method embodiments may be understood as input of the chip.

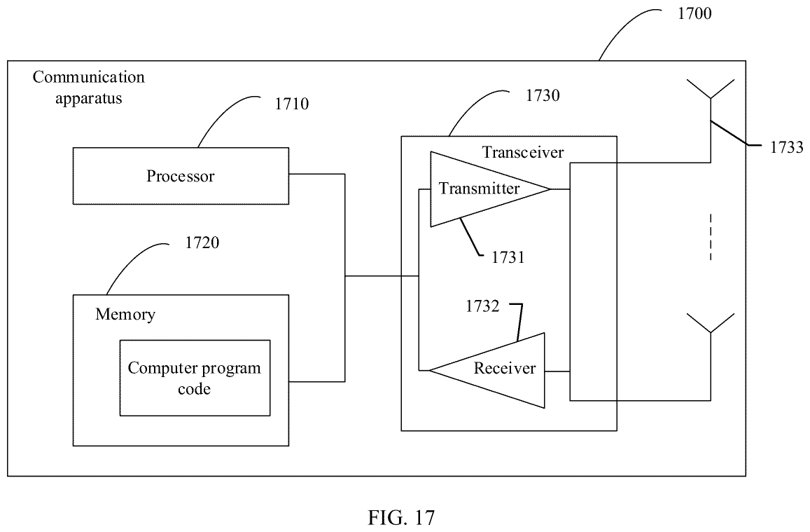

FIG. 17 is a block diagram of a communication apparatus 1700 according to an embodiment of this application. The communication apparatus 1700 may be a terminal device, a processor of a terminal device, or a chip. The communication apparatus 1700 may be configured to perform an operation performed by the terminal device or a communication device in the foregoing method embodiments.

When the communication apparatus 1700 is a terminal device, FIG. 17 is a diagram of a simplified structure of the terminal device. As shown in FIG. 17, the terminal device includes a processor, a memory, and a transceiver. The memory may store computer program code. The transceiver includes a transmitter 1731, a receiver 1732, a radio frequency circuit (which is not shown in the figure), an antenna 1733, and an input/output apparatus (which is not shown in the figure).

The processor is mainly configured to: process a communication protocol and communication data, control the terminal device, execute a software program, process data of the software program, and the like. The memory is mainly configured to store the software program and data. The radio frequency circuit is mainly configured to: perform conversion between a baseband signal and a radio frequency signal, and process the radio frequency signal. The antenna is mainly configured to receive/send a radio frequency signal in a form of an electromagnetic wave. The input/output apparatus, for example, a touchscreen, a display screen, or a keyboard, is mainly configured to receive data input by a user and output data to the user. It should be noted that some types of terminal devices may have no input/output apparatus.

When needing to send data, after performing baseband processing on the to-be-sent data, the processor outputs a baseband signal to the radio frequency circuit; and the radio frequency circuit performs radio frequency processing on the baseband signal and then sends a processed radio frequency signal to the outside in a form of an electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data. For ease of description, FIG. 17 shows only one memory, one processor, and one transceiver. In an actual terminal device product, there may be one or more processors and one or more memories. The memory may also be referred to as a storage medium, a storage device, or the like. The memory may be disposed independent of the processor, or may be integrated with the processor. This is not limited in embodiments of this application.

In this embodiment of this application, the antenna and the radio frequency circuit that have sending and receiving functions may be considered as a transceiver module of the terminal device, and the processor that has a processing function may be considered as a processing module of the terminal device.

As shown in FIG. 17, the terminal device includes a processor 1710, a memory 1720, and a transceiver 1730. The processor 1710 may also be referred to as a processing unit, a processing board, a processing module, a processing apparatus, or the like, and the transceiver 1730 may also be referred to as a transceiver unit, a transceiver machine, a transceiver apparatus, or the like.

Optionally, a component configured to implement a receiving function in the transceiver 1730 may be considered as a receiver, and a component configured to implement a sending function in the transceiver 1730 may be considered as a transmitter. In other words, the transceiver 1730 includes the receiver and the transmitter. The transceiver may also be sometimes referred to as a transceiver machine, a transceiver module, a transceiver circuit, or the like. The receiver may also be sometimes referred to as a receiver machine, a receiving module, a receiver circuit, or the like. The transmitter may also be sometimes referred to as a transmitter machine, a transmitting module, a transmitter circuit, or the like.

For example, in an implementation, the processor 1710 is configured to perform a processing action on a terminal device side in the embodiments shown in FIG. 2 to FIG. 12, and the transceiver 1730 is configured to perform receiving and sending actions on the terminal device side in FIG. 2 to FIG. 12.

It should be understood that FIG. 17 is merely an example rather than a limitation. The terminal device including the transceiver module and the processing module may not depend on the structures shown in FIG. 13 to FIG. 15.

When the communication apparatus 1700 is a chip, the chip includes a processor, a memory, and a transceiver. The transceiver may be an input/output circuit or a communication interface. The processor may be a processing module, a microprocessor, or an integrated circuit integrated on the chip. A sending operation performed by the terminal device in the foregoing method embodiments may be understood as output of the chip, and a receiving operation performed by the terminal device in the foregoing method embodiments may be understood as input of the chip.

This application further provides a chip, including a processor, configured to invoke instructions from a memory and run the instructions stored in the memory, so that a communication device on which the chip is installed is enabled to perform the methods in the foregoing examples.

This application further provides another chip, including an input interface, an output interface, and a processor. The input interface, the output interface, and the processor are connected through an internal connection path. The processor is configured to execute code in a memory, and when the code is executed, the processor is configured to perform the methods in the foregoing examples. Optionally, the chip further includes the memory, and the memory is configured to store a computer program or the code.

This application further provides a processor, configured to couple to a memory, and configured to perform the method and the function of the network device or the terminal device in any one of the foregoing embodiments.

Another embodiment of this application provides a computer program product including instructions. When the computer program product runs on a computer, the method in the foregoing embodiment is implemented.

This application further provides a computer program. When the computer program is run on a computer, the method in the foregoing embodiment is implemented.

Another embodiment of this application provides a computer-readable storage medium. The computer-readable storage medium stores a computer program. When the computer program is executed by a computer, the method in the foregoing embodiment is implemented.

In the descriptions in embodiments of this application, unless otherwise specified, “a plurality of” means two or more than two. “At least one of the following items (pieces)” or a similar expression thereof indicates any combination of these items, including a single item (piece) or any combination of a plurality of items (pieces). For example, at least one item (piece) of a, b, or c may indicate: a, b, c, a and b, a and c, b and c, or a, b, and c, where a, b, and c may be singular or plural.

In addition, to clearly describe the technical solutions in embodiments of this application, terms such as “first” and “second” are used in embodiments of this application to distinguish between same items or similar items that have a basically same function and purpose. A person skilled in the art may understand that the terms such as “first” and “second” do not limit a quantity or an execution sequence, and the terms such as “first” and “second” do not indicate a definite difference. In addition, in embodiments of this application, the terms such as “example” or “for example” are used to represent giving an example, an illustration, or a description.

Any embodiment or design solution described as “example” or “for example” in embodiments of this application should not be explained as being more preferred or having more advantages than another embodiment or design solution. Exactly, use of the term such as “example” or “for example” is intended to present a related concept in a specific manner for ease of understanding.

In the descriptions of embodiments of this application, “/” represents an “or” relationship between associated objects unless otherwise specified. For example, A/B may represent A or B. In this application, “and/or” describes only an association relationship between associated objects, and represents that three relationships may exist. For example, A and/or B may represent the following three cases: A exists alone, both A and B exist, and B exists alone, where A and B may be singular or plural.

Sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed.

In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When functions are implemented in a form of a software functional unit and sold or used as an independent product, the functions may be stored in a computer-readable storage medium. Based on such an understanding, the technical solutions in embodiments of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, for example, a USB flash drive, a removable hard disk, a ROM, a RAM, a magnetic disk, or an optical disc.

The foregoing descriptions are merely specific implementations in embodiments of this application, but are not intended to limit the protection scope in embodiments of this application. Any variation or replacement readily figured out by a person skilled in the art within the technical scope disclosed in embodiments of this application shall fall within the protection scope in embodiments of this application. Therefore, the protection scope of embodiments of this application should be subject to the protection scope of the claims.

1. A data transmission method, comprising:
receiving, by a first communication apparatus, first information, wherein the first information is used to schedule transmission of first data and transmission of second data, the first data corresponds to a first reliability level, the second data corresponds to a second reliability level, and the first reliability level is different from the second reliability level;
determining, by the first communication apparatus, second information, wherein a first correspondence exists between the second information and both the first reliability level and the second reliability level; and
transmitting, by the first communication apparatus, the first data and the second data based on the second information.

2. The method according to claim 1, wherein the second information comprises at least one of the following:
a layer number of a transport block, a time domain resource, a frequency domain resource, a logical channel, a code block unit, a modulation and coding scheme (MCS) table, or an MCS index.

3. The method according to claim 2, wherein
the second information comprises the layer number of the transport block, and the layer number of the transport block comprises a layer number of a first transport block and a layer number of a second transport block, the layer number of the first transport block corresponds to the first reliability level, and the layer number of the second transport block corresponds to the second reliability level; or
the second information comprises the time domain resource, and the time domain resource comprises a first time domain resource and a second time domain resource, the first time domain resource corresponds to the first reliability level, and the second time domain resource corresponds to the second reliability level; or
the second information comprises the frequency domain resource, and the frequency domain resource comprises a first frequency domain resource and a second frequency domain resource, the first frequency domain resource corresponds to the first reliability level, and the second frequency domain resource corresponds to the second reliability level; or
the second information comprises the logical channel, and the logical channel comprises a first logical channel and a second logical channel, the first logical channel corresponds to the first reliability level, and the second logical channel corresponds to the second reliability level; or
the second information comprises the code block unit, and the code block unit comprises a first code block unit and a second code block unit, the first code block unit corresponds to the first reliability level, and the second code block unit corresponds to the second reliability level; or
the second information comprises the MCS table, and the MCS table comprises a first MCS table and a second MCS table, the first MCS table corresponds to the first reliability level, and the second MCS table corresponds to the second reliability level; or
the second information comprises the MCS index, and the MCS index comprises a first MCS index and a second MCS index, the first MCS index corresponds to the first reliability level, the second MCS index corresponds to the second reliability level, the first MCS index corresponds to the first MCS table, and the second MCS index corresponds to the second MCS table.

4. The method according to claim 3, wherein:
the second information comprises the logical channel, and the logical channel comprises the first logical channel and the second logical channel, the first logical channel corresponds to the first reliability level, and the second logical channel corresponds to the second reliability level;
the second information comprises the code block unit, and the code block unit comprises the first code block unit and the second code block unit, the first code block unit corresponds to the first reliability level, and the second code block unit corresponds to the second reliability level; and
the first logical channel corresponds to the first code block unit, and the second logical channel corresponds to the second code block unit.

5. The method according to claim 3, wherein the second information comprises the code block unit, and the code block unit comprises the first code block unit and the second code block unit, the first code block unit corresponds to the first reliability level, and the second code block unit corresponds to the second reliability level the first code block unit is configured to transmit the first data, the second code block unit is configured to transmit the second data, and the first code block unit and the second code block unit belong to a third transport block; and the first code block unit and the second code block unit meet any one of the following:
the first code block unit comprises a first transport block cyclic redundancy check, and the second code block unit does not comprise the first transport block cyclic redundancy check; or
the first code block unit does not comprise a first transport block cyclic redundancy check, and the second code block unit comprises the first transport block cyclic redundancy check; or
the first code block unit comprises a first transport block cyclic redundancy check, and the second code block unit comprises a second transport block cyclic redundancy check; or
the first code block unit comprises a first code block cyclic redundancy check, and the second code block unit does not comprise the first code block cyclic redundancy check; or
the first code block unit comprises a first code block cyclic redundancy check, and the second code block unit comprises a second code block cyclic redundancy check.

6. The method according to claim 1, wherein the second information further comprises:
an index, wherein the index indicates at least one of the MCS table and the MCS index.

7. The method according to claim 6, wherein the index comprises at least one of:
a first index, indicating the first MCS table and the first MCS index;
a second index, indicating the second MCS table and the second MCS index;
a third index, indicating the first MCS index and the second MCS index;
a fourth index, indicating the first MCS table and the second MCS table;
a fifth index, indicating the first MCS table;
a sixth index, indicating the first MCS index;
a seventh index, indicating the second MCS table;
an eighth index, indicating the second MCS index; or
a ninth index, indicating the first MCS table, the first MCS index, the second MCS table, and the second MCS index.

8. The method according to claim 7, wherein the index comprises the first index and the second index, and a difference between the first MCS index and the second MCS index is a first value; and
the second MCS index is determined by the first communication apparatus based on the first MCS index and the first value; or
the first MCS index is determined by the first communication apparatus based on the second MCS index and the first value.

9. The method according to claim 7, wherein the index comprises the first index and the second index, and a difference between an index of the first MCS table and an index of the second MCS table is a second value; and
the index of the second MCS table is determined by the first communication apparatus based on the index of the first MCS table and the second value; or
the index of the first MCS table is determined by the first communication apparatus based on the index of the second MCS table and the second value.

10. The method according to claim 1, wherein the first information further indicates the first reliability level and the second reliability level.

11. A data transmission method, comprising:
receiving, by a first communication apparatus, third information, wherein the third information indicates the first communication apparatus to perform measurement feedback on a first channel and measurement feedback on a second channel, the first channel corresponds to a third reliability level, and the second channel corresponds to a fourth reliability level;
determining, by the first communication apparatus, fourth information, wherein a second correspondence exists between the fourth information and both the third reliability level and the fourth reliability level; and
sending, by the first communication apparatus, measurement feedback information of the first channel and measurement feedback information of the second channel based on the fourth information.

12. The method according to claim 11, wherein the fourth information comprises at least one of the following:
a layer number of a transport block, a channel quality indicator (CQI) table, or a signal-to-noise ratio threshold.

13. The method according to claim 12, wherein
the fourth information comprises the layer number of the transport block, and the layer number of the transport block comprises a layer number of a fourth transport block and a layer number of a fifth transport block, the layer number of the fourth transport block corresponds to the third reliability level, and the layer number of the fifth transport block corresponds to the fourth reliability level; or
the fourth information comprises the CQI table, and the CQI table comprises a first CQI table and a second CQI table, the first CQI table corresponds to the third reliability level, and the second CQI table corresponds to the fourth reliability level.

14. The method according to claim 13, wherein the fourth information comprises the signal-to-noise ratio threshold, and the signal-to-noise ratio threshold is used to determine the layer number of the fourth transport block and the layer number of the fifth transport block; and
a signal-to-noise ratio of each of layers of the fourth transport block is greater than or equal to the signal-to-noise ratio threshold, and a signal-to-noise ratio of each of layers of the fifth transport block is less than the signal-to-noise ratio threshold; or
a signal-to-noise ratio of each of layers of the fourth transport block is less than the signal-to-noise ratio threshold, and a signal-to-noise ratio of each of layers of the fifth transport block is greater than or equal to the signal-to-noise ratio threshold.

15. A data transmission method, comprising:
sending, by a second communication apparatus, first information, wherein the first information is used to schedule transmission of first data and transmission of second data, the first data corresponds to a first reliability level, the second data corresponds to a second reliability level, and the first reliability level is different from the second reliability level;
determining, by the second communication apparatus, second information, wherein a first correspondence exists between the second information and both the first reliability level and the second reliability level; and
transmitting, by the second communication apparatus, the first data and the second data based on the second information.

16. The method according to claim 15, wherein the second information comprises at least one of the following:
a layer number of a transport block, a time domain resource, a frequency domain resource, a logical channel, a code block unit, a modulation and coding scheme (MCS) table, or an MCS index.

17. The method according to claim 16, wherein
the second information comprises the layer number of the transport block, and the layer number of the transport block comprises a layer number of a first transport block and a layer number of a second transport block, the layer number of the first transport block corresponds to the first reliability level, and the layer number of the second transport block corresponds to the second reliability level; or
the second information comprises the time domain resource, and the time domain resource comprises a first time domain resource and a second time domain resource, the first time domain resource corresponds to the first reliability level, and the second time domain resource corresponds to the second reliability level; or
the second information comprises the frequency domain resource, and the frequency domain resource comprises a first frequency domain resource and a second frequency domain resource, the first frequency domain resource corresponds to the first reliability level, and the second frequency domain resource corresponds to the second reliability level; or
the second information comprises the logical channel, and the logical channel comprises a first logical channel and a second logical channel, the first logical channel corresponds to the first reliability level, and the second logical channel corresponds to the second reliability level; or
the second information comprises the code block unit, and the code block unit comprises a first code block unit and a second code block unit, the first code block unit corresponds to the first reliability level, and the second code block unit corresponds to the second reliability level; or
the second information comprises the MCS table, and the MCS table comprises a first MCS table and a second MCS table, the first MCS table corresponds to the first reliability level, and the second MCS table corresponds to the second reliability level; or
the second information comprises the MCS index, and the MCS index comprises a first MCS index and a second MCS index, the first MCS index corresponds to the first reliability level, the second MCS index corresponds to the second reliability level, the first MCS index corresponds to the first MCS table, and the second MCS index corresponds to the second MCS table.

18. The method according to claim 17, wherein:
the second information comprises the logical channel, and the logical channel comprises the first logical channel and the second logical channel, the first logical channel corresponds to the first reliability level, and the second logical channel corresponds to the second reliability level;
the second information comprises the code block unit, and the code block unit comprises the first code block unit and the second code block unit, the first code block unit corresponds to the first reliability level, and the second code block unit corresponds to the second reliability level; and
the first logical channel corresponds to the first code block unit, and the second logical channel corresponds to the second code block unit.

19. The method according to claim 17, wherein the second information comprises the code block unit, and the code block unit comprises the first code block unit and the second code block unit, the first code block unit corresponds to the first reliability level, and the second code block unit corresponds to the second reliability level the first code block unit is configured to transmit the first data, the second code block unit is configured to transmit the second data, and the first code block unit and the second code block unit belong to a third transport block; and the first code block unit and the second code block unit meet any one of the following:
the first code block unit comprises a first transport block cyclic redundancy check, and the second code block unit does not comprise the first transport block cyclic redundancy check; or
the first code block unit does not comprise a first transport block cyclic redundancy check, and the second code block unit comprises the first transport block cyclic redundancy check; or
the first code block unit comprises a first transport block cyclic redundancy check, and the second code block unit comprises a second transport block cyclic redundancy check; or
the first code block unit comprises a first code block cyclic redundancy check, and the second code block unit does not comprise the first code block cyclic redundancy check; or
the first code block unit comprises a first code block cyclic redundancy check, and the second code block unit comprises a second code block cyclic redundancy check.

20. The method according to claim 15, wherein the second information further comprises:
an index, wherein the index indicates at least one of the MCS table and the MCS index.
